(19) United States
(12) Patent Application Publication
(10) Pub. No.: US 2023/0182616 A1
(43) Pub. Date: Jun. 15, 2023

(54) SYSTEM AND METHOD FOR DETERMINING RANGE AND CAPACITY OF SUPERCAPACITOR BATTERY STORAGE FOR ELECTRIC VEHICLE

(71) Applicant: SUSTAINABLE ENERGY TECHNOLOGIES, INC., Wilmington, DE (US)

(72) Inventor: John Cronin, Wilmington, DE (US)

(21) Appl. No.: 18/076,259

(22) Filed: Dec. 6, 2022

Related U.S. Application Data
(60) Provisional application No. 63/286,418, filed on Dec. 6, 2021.

(51) Int. Cl. B60L 58/10; B60W 50/08; B60W 40/00; B60W 50/14; H01M 10/42; H01M 10/48

(52) U.S. Cl. CPC B60L 58/10; B60W 50/085; B60W 40/00; B60W 50/14; H01M 10/4264; H01M 10/48; B60W 2520/00; B60W 2050/146; B60W 2556/10; H01M 2010/4271; H01M 2220/20

(57) ABSTRACT

Disclosed herein are systems and methods for energy-based vehicle analysis. A vehicle includes an energy storage unit that is configured to store energy. An energy attribute sensor measures one or more attributes of the energy storage unit. A vehicle attribute sensor measures one or more attributes of the vehicle. The energy storage unit is configured to power a propulsion mechanism of the vehicle. A control system with a processor and a memory estimates a capacity of the energy storage unit based on the one or more attributes of the energy storage unit. The control system estimates a range that the vehicle is capable of reaching using the propulsion mechanism based on the one or more attributes of the vehicle and the estimated capacity of the energy storage unit. The control system causes an output interface to output an indication of the estimated range.

### CROSS-REFERENCE TO RELATED APPLICATIONS

This application claims the benefit of U.S. Provisional Application No. 63/286,418, filed Dec. 6, 2021, for “SYSTEM AND METHOD FOR DETERMINING RANGE AND CAPACITY OF SUPERCAPACITOR BATTERY STORAGE FOR ELECTRIC VEHICLE,” the disclosure of which is incorporated herein by reference in its entirety.

### FIELD OF THE DISCLOSURE

The present disclosure is generally related to prediction of attribute(s) of a vehicle based on attribute(s) of energy storage unit(s) of the vehicle, for instance to prediction of a range of the vehicle based on a capacity of the energy storage unit(s) of the vehicle.

### BACKGROUND

Some vehicles, such as electric vehicles or hybrid vehicles, include energy storage units such as batteries to power components and subsystems of the vehicles. For instance, in some vehicles, power from the energy storage units is used to power propulsion mechanisms, such as motors and/or engines, that propel the vehicle. Such a vehicle's effective driving range can be limited by how much power can be provided by its energy storage units. A supercapacitor is a type of capacitor that can be used as an energy storage unit.

### SUMMARY

Disclosed herein are systems and methods for energy-based vehicle analysis. A vehicle includes an energy storage unit that is configured to store energy. An energy attribute sensor measures one or more attributes of the energy storage unit. A vehicle attribute sensor measures one or more attributes of the vehicle. The energy storage unit is configured to power a propulsion mechanism of the vehicle. A control system with a processor and a memory estimates a capacity of the energy storage unit based on the one or more attributes of the energy storage unit. The control system estimates a range that the vehicle is capable of reaching using the propulsion mechanism based on the one or more attributes of the vehicle and the estimated capacity of the energy storage unit. The control system causes an output interface to output an indication of the estimated range.

In an illustrative example, a system is disclosed for vehicle energy architecture customization. The system comprises: an energy storage unit that is configured to store energy; an energy attribute sensor that is configured to measure one or more attributes of the energy storage unit; a vehicle attribute sensor that is configured to measure one or more attributes of a vehicle, wherein the energy storage unit is configured to power a propulsion mechanism of the vehicle; a control system comprising a processor with access to a memory, wherein the control system is configured to estimate a capacity of the energy storage unit based on the one or more attributes of the energy storage unit, wherein the control system is configured to estimate a range that the vehicle is capable of reaching using the propulsion mechanism based on the one or more attributes of the vehicle and the estimated capacity of the energy storage unit; and an output interface coupled to the control system and configured to output an indication of the estimated range.

In another illustrative example, a method is disclosed for vehicle energy architecture customization. The method comprises: measuring one or more attributes of an energy storage unit using an energy attribute sensor, wherein the energy storage unit is configured to store energy; measuring one or more attributes of a vehicle using a vehicle attribute sensor, wherein the energy storage unit is configured to power a propulsion mechanism of the vehicle; estimating a capacity of the energy storage unit based on the one or more attributes of the energy storage unit; estimating a range that the vehicle is capable of reaching using the propulsion mechanism based on the one or more attributes of the vehicle and the estimated capacity of the energy storage unit; and outputting an indication of the estimated range using an output interface.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram illustrating an architecture of an energy management system, according to some examples.

FIG. 2 is a flow diagram illustrating a process performed using a capability base module, according to some examples.

FIG. 3 is a flow diagram illustrating a process performed using testing capability module, according to some examples.

FIG. 4 is a flow diagram illustrating a process performed using a testing history module, according to some examples.

FIG. 5 is a flow diagram illustrating a process performed using a testing current module, according to some examples.

FIG. 6 is a flow diagram illustrating a process performed using a range compute module, according to some examples.

FIG. 7 is a flow diagram illustrating a process performed using a range history module, according to some examples.

FIG. 8 is a flow diagram illustrating a process performed using a range current module, according to some examples.

FIG. 9 is a flow diagram illustrating a process performed using a capacity compute module, according to some examples.

FIG. 10 is a flow diagram illustrating a process performed using a capacity history module, according to some examples.

FIG. 11 is a flow diagram illustrating a process performed using a capacity current module, according to some examples.

FIG. 12 is a flow diagram illustrating a process performed using an AI module, according to some examples.

FIG. 13 is a block diagram illustrating use of one or more trained machine learning models of a machine learning engine to identify an energy storage unit's capacity and/or a vehicle's range based on attribute data, according to some examples.

FIG. 14 is a flow diagram illustrating a process for energy-based vehicle analysis performed using a control system, according to some examples.

### DETAILED DESCRIPTION

Aspects of the present disclosure are disclosed in the following description and related figures directed to specific embodiments of the disclosure. Those of ordinary skill in the art will recognize that alternate embodiments may be devised without departing from the claims' spirit or scope. Additionally, well-known elements of exemplary embodiments of the disclosure will not be described in detail or will be omitted so as not to obscure the relevant details of the disclosure

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the disclosure, embodiments, or disclosure do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present disclosure may be embodied in several different forms, all of which have been contemplated to be within the scope of the claimed subject matter. In addition, for each of the embodiments described herein, the corresponding form of any such embodiments may be described herein as, for example, a computer configured to perform the described action.

Disclosed herein are systems and methods for energy-based vehicle analysis. A vehicle includes an energy storage unit that is configured to store energy. An energy attribute sensor measures one or more attributes of the energy storage unit. A vehicle attribute sensor measures one or more attributes of the vehicle. The energy storage unit is configured to power a propulsion mechanism of the vehicle. A control system with a processor and a memory estimates a capacity of the energy storage unit based on the one or more attributes of the energy storage unit. The control system estimates a range that the vehicle is capable of reaching using the propulsion mechanism based on the one or more attributes of the vehicle and the estimated capacity of the energy storage unit. The control system causes an output interface to output an indication of the estimated range.

With respect to the embodiments, a summary of the terminology used herein is provided.

### Energy Storage Unit (ESU):

The ESU is a device that can store and deliver charge. It may comprise one or more power packs which in turn may comprise supercapacitors. The energy storage module may also comprise batteries, hybrid systems, fuel cells, etc. Capacitance provided in the components of the ESU may be in the form of electrostatic capacitance, pseudocapacitance, electrolytic capacitance, electronic double-layer capacitance, and electrochemical capacitance, and a combination thereof, such as both electrostatic double-layer capacitance and electrochemical pseudocapacitance, as may occur in supercapacitors. The ESU may be associated with or comprise control hardware and software with suitable sensors, as needed, for an energy control system (ECS) to manage any of the following: temperature control, discharging of the ESU whether collectively or of any of its components, charging of the ESU whether collectively or of any of its components, maintenance, interaction with batteries, battery emulation, communication with other devices, including devices that are directly connected, adjacent, or remotely such as by wireless communication, etc. In some aspects, the ESU may be portable and provided in a casing containing at least some components of the energy control system (ECS) and features such as communication systems, a display interface, etc.

The term supercapacitor as used herein can also refer to an ultracapacitor, which is an electrical component capable of holding hundreds of times more electrical charge quantity than a standard capacitor. This characteristic makes ultracapacitors useful in devices that require relatively little current and low voltage. In some situations, an ultracapacitor can take the place of a rechargeable low-voltage electrochemical battery. In some examples, the terms supercapacitor or ultracapacitor as used herein can also refer to other types of capacitors.

### Energy Control System (ECS)

The energy control system (ECS) combines hardware and software that manages various aspects of the ESU, including its energy to the device. The ECS regulates the energy storage unit (ESU) to control discharging, charging, and other features as desired, such as temperature, safety, efficiency, etc. The ESU may be adapted to give the ECS individual control over each power pack or optionally over each supercapacitor or grouped supercapacitor unit to tap the available power of individual supercapacitors efficiently and to properly charge individual supercapacitors rather than merely providing a single level of charge for the ESU as a whole that may be too little or too much for individual supercapacitors or their power packs.

The ECS may comprise or be operatively associated with a processor, a memory comprising code for the controller, a database, and communication tools such as a bus or wireless capabilities for interacting with an interface or other elements or otherwise providing information, information requests, or commands. The ECS may interact with individual power packs or supercapacitors through a crosspoint switch or other matrix systems. Further, the ECS may obtain information from individual power packs or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack or supercapacitor.

The ECS may comprise one or more modules that the processor can execute or govern according to code stored in a memory such as a chip, a hard drive, a cloud-based source, or another computer-readable medium.

The ECS may therefore manage any or all of the following: temperature control, discharging of the ESU whether collectively or of any of its components, charging of the ESU whether collectively or of any of its components, maintenance, interaction with batteries, or battery emulation, and communication with other devices, including devices that are directly connected, adjacent, or remotely such as by wireless communication.

The ECS may comprise one or more energy source modules that govern specific energy storage devices, such as a supercapacitor module for governing supercapacitors and a lithium module for governing lithium batteries. A lead-acid module for governing lead-acid batteries and a hybrid module for governing the combined cooperative use of a supercapacitor and a battery. Each of the energy storage modules may comprise software encoding algorithms for control such as for discharge or charging or managing individual energy sources, and may comprise or be operationally associated with hardware for redistributing charge among the energy sources to improve the efficiency of the ESU, for monitoring charge via charge measurement systems such as circuits for determining the charge state of the respective energy sources, etc., and may comprise or be operationally associated with devices for receiving and sending information to and from the ECS or its other modules, etc. The energy source modules may also cooperate with a charging module responsible for guiding the charging of the overall ESU to ensure a properly balanced charge and a discharge module that guides the efficient discharging of the ESU during use which may also seek to provide proper balance in the discharging of the energy sources.

The ECS may further comprise a dynamic module for managing changing requirements in power supplied. In some aspects, the dynamic module comprises anticipatory algorithms that seek to predict upcoming changes in power demand and adjust the state of the ECS to be ready to handle the change more effectively. For example, in one case, the ECS may communicate with a GPS and terrain map for the route being taken by the electric vehicle and recognize that a steep hill will soon be encountered. The ECS may anticipate the need to increase torque and thus the delivered electrical power from the ESU and thus activate additional power packs if only some are in use or otherwise increase the draw from the power packs to handle the change in slope efficiently to achieve desired objectives such as maintaining speed, reducing the need to shift gears on a hill, or reducing the risk of stalling or other problems.

The ECS may also comprise a communication module and an associated configuration system to properly configure the ECS to communicate with the interface or other aspects of the vehicle and communicate with central systems or other vehicles when desired. In such cases, a fleet of vehicles may be effectively monitored and managed to improve energy efficiency and track the performance of vehicles and their ESUs, thereby providing information that may assist with maintenance protocols. Such communication may occur wirelessly or through the cloud via a network interface, share information with various central databases, or access information from databases to assist with the vehicle's operation and the optimization of the ESU, for which historical data may be available in a database.

Databases of use with the ECS include databases on the charge and discharge behavior of the energy sources in the ESU to optimize both charging and discharging in use based on known characteristics, databases of topographical and other information for a route to be taken by the electric vehicle or an operation to be performed by another device employing the ESU, wherein the database provides guidance on what power demands are to be expected in advance to support anticipatory power management wherein the status of energy sources. The available charge is prepared in time to deliver the needed power proactively. Charging databases may also help describe the characteristics of an external power source used to charge the ESU. Knowledge of the external charge characteristics can prepare for impedance matching or other measures needed to handle a new input source to charge the ESU. With that data, the external power can be received with reduced losses and reduced risk of damaging elements in the ESU by overcharge, an excessive ripple in the current, etc.

Beyond relying on static information in databases, in some aspects, the controller is adapted to perform machine learning and to learn from situations faced constantly. In related aspects, the processor and the associated software form a “smart” controller based on machine learning or artificial intelligence adapted to handle a wide range of input and a wide range of operational demands.

### ESU Hardware

### Charging and Discharging Hardware

The charging and discharging hardware comprises the wiring, switches, charge detection circuits, current detection circuits, and other devices for proper control of charge applied to the power packs or the batteries or other energy storage units and temperature-control devices such as active cooling equipment and other safety devices. Active cooling devices (not shown) may include fans, circulating heat transfer fluids that pass through tubing or, in some cases, surround or immerse the power packs, thermoelectric cooling such as Peltier effect coolers, etc.

To charge and discharge an individual unit among the power packs to optimize the overall efficiency of the ESU, methods are needed to select one or more of many units from what may be a three-dimensional or two-dimensional array of connectors to the individual units. Any suitable methods and devices may be used for such operations, including crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. SPST (Single-Pole Single-Throw) relays, for example, may be used. By applying a charge to individual supercapacitors within power packs or to individual power packs within the ESU, a charge can be applied directly to where it is needed, and a supercapacitor or power pack can be charged to an optimum level independently of other power packs or supercapacitors.

### Configuration Hardware

The configuration hardware comprises the switches, wiring, and other devices to transform the electrical configuration of the power packs between series and parallel configurations, such as that a matrix of power packs may be configured to be in series, in parallel, or some combination thereof. For example, a 12×6 array of power packs may have four groups in series, with each group having 3×6 power packs in parallel. A command can modify the configuration from the configuration module, which then causes the configuration hardware to make the change at an appropriate time (e.g., when the device is not in use).

### Sensors

The sensors may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs or batteries or other energy storage units or other characteristics of the ESU or the device as described more fully hereafter. The sensors may comprise sensors physically contained in or on the ESU or sensors mounted elsewhere, such as engine gauges in electronic communication with the ECS or its associated ESC.

### Batteries and Other Energy Sources

The ESU may be capable of charging or supplementing the power provided from the batteries or other energy storage units, including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox flow batteries, supercapacitor batteries, and combinations or hybrids thereof.

### Power Input/Output Interface

The ESU also comprises or is associated with a power input/output interface 152 that can receive charge from a device (or a plurality of devices in some cases) such as the grid or regenerative power sources in an electric vehicle (not shown) and can deliver charge to a device such as an electric vehicle (not shown). The power input/output interface may comprise one or more inverters, charge converters, or other circuits and devices to convert the current to the proper type (e.g., AC or DC) and voltage or amperage for either supplying power to or receiving power from the device it is connected to. Bidirectional DC-DC converters may also be applied.

The power input/output interface may be adapted to receive power from various power sources, such as via two-phase or three-phase power, DC power, etc. It may receive or provide power by wires, inductively, or any other proper means. Converters, transformers, rectifiers, and the like may be employed as needed. The power received may be relatively steady from the grid, or other sources at voltages such as 110V, 120V, 220V, 240V, etc., or from highly variable sources such as solar or wind power amperage or voltage vary. DC sources may be, by way of example, from 1V to 0V or higher, such as from 4V to 200V, 5V to 120V, 6V to V, 2V to 50V, 3V to 24V, or nominal voltages of about 4, 6, 12, 18, 24, 30, or 48 V. Similar ranges may apply to AC sources, but also including from 60V to 300V, from 90V to 250V, from V to 240 V, etc., operating at any proper frequency such as 50 Hz, 60 Hz, Hz, etc.

Power received or delivered may be modulated, converted, smoothed, rectified, or transformed in any useful way to meet better the application's needs and the requirements of the device and the ESU. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient power transfer.

The power input/out interface may have a plurality of receptacles of receiving power and a plurality of outlets for providing power to one or more devices. Conventional AC outlets may include any known outlet standard in North America, various parts of Europe, China, Hong Kong, etc.

### Energy Control System (ECS)

The energy storage unit (ESU) is governed or controlled by a novel energy control system (ECS) adapted to optimize at least one of charging, discharging, temperature management, safety, security, maintenance, and anticipatory power delivery. The ECS may communicate with a user interface such as a display interface to assist in control or monitoring of the ESU and also may comprise a processor and a memory. The ECS may interact with the ESU's hardware, such as the charging/discharging hardware and a temperature control system that provides data to the ECS and responds to directions from the ECS to manage the ESU.

The energy control system (ECS) may comprise a processor, a memory, one or more energy source modules, a charge/discharge module, a communication module, a configuration module, a dynamic module, an identifier module, a security module, a safety module, a maintenance module, and a performance module.

### ECS Components and Modules

### Processor

The processor may comprise one or more microchips or other systems for executing electronic instructions and can provide instructions to regulate the charging and discharging hardware and, when applicable, the configuration hardware or other aspects of the ESU and other aspects of the ECS and its interactions with the device, the cloud, etc. In some cases, a plurality of processors may collaborate, including processors installed with the ESU and processors installed in a vehicle or other device.

### Memory

The memory may comprise coding to operate one or more of the ECS and their interactions with other components. It may also comprise information such as databases on any aspect of the operation of the ECS, though additional databases are also available via the cloud. Such databases can include a charging database that describes the charging and discharging characteristics of a plurality or all energy sources (the power packs and the batteries or other energy storage units) to guide charging and discharging operations. Such data may also be included with energy-source-specific data provided by or accessed by the energy source modules.

The memory may be in one or more locations or components such as a memory chip, a hard drive, a cloud-based source, or another computer-readable medium, and maybe in any application form such as flash memory, EPROM, EEPROM, PROM, MROM, etc., or combinations thereof and consolidated (centralized) or distributed forms. The memory may, in whole or part, be a read-only memory (ROM) or random-access memory (RAM), including static RAM (SRAM), dynamic RAM (DRAM), synchronous dynamic RAM (SDRAM), and magneto-resistive RAM (MRAM), etc.

### Cloud Resources

The ECS may communicate with other entities via the cloud or other means. Such communication may involve information received from and provided to one or more databases and a message center. The message center can provide alerts to an administrator responsible for the ESU and the electric vehicle or another device. For example, an entity may own a fleet of electric vehicles using ESUs and may wish to receive notifications regarding usage, performance, maintenance issues, and so forth. The message center may also authenticate the ESU or verify its authorization for use in the electric vehicle or other devices (not shown) via interaction with the security module.

### Energy Source Modules

The energy source modules may comprise specific modules designed to operate a specific energy source, such as a supercapacitor module, a lithium battery module, a lead-acid battery module, or other modules. Such modules may be associated with a database of performance characteristics (e.g., charge and discharge curves, safety restrictions regarding overcharge, temperature, etc.) that may provide information for use by the safety module and the charge/discharge module, which is used to optimize how each unit within the power packs or batteries or other energy storage units is used both in terms of charging and delivering charge. The charge/discharge module seeks to provide useful work from as much of the charge as possible in the individual power packs while ensuring that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

### Charge/Discharge Module

The charge/discharge module is used to optimize how each unit within the power packs, batteries, or other energy storage units is used to charge and deliver charge. The charge/discharge module seeks to provide useful work from as much of the charge as possible in the individual power packs while ensuring during charging that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

The charge/discharge module may be configured to charge or discharge each of the plurality of power packs up to a threshold limit. The charge/discharge module may be coupled to the performance, energy storage, and identifier modules. It may communicate with the charging/discharging hardware of the ESU. For example, the threshold limit may be more than 90 percent capacity of each of the plurality of power packs in one aspect.

### Dynamic Module

The dynamic module assists in coping with changes in operation, including acceleration, deceleration, stops, changes in slops (uphill or downhill), changes in traction or properties of the road or ground that affect traction and performance, etc., by optimizing the delivery of power or the charging that is taking place for individual power packs or batteries or other energy storage units. In addition to guiding the degree of power provided by or to individual power packs based on the current use of the device and the individual state of the power packs, in some aspects, the dynamic module provides anticipatory management of the ESU by proactively adjusting the charging or discharging states of the power packs such that added power is available as the need arises or slightly in advance (depending on time constants for the ESU and its components, anticipatory changes in status may only be needed for a few seconds (e.g., 5 seconds or less or 2 seconds or less) or perhaps only for 1 second or less such as for 0.5 seconds or less. Still, more extended preparatory changes may be needed in other cases, such as from 3 seconds to 10 seconds, to ensure that adequate power is available when needed but that power is not wasted by changing the power delivery state prematurely. This anticipatory control can involve not only increasing the current or voltage being delivered. Still, it can also involve increasing the cooling provided by the cooling hardware of the charging and discharging hardware in cooperation with the safety module and when suitable with the charge/discharge module.

The dynamic module may be communicatively coupled to the charge/discharge module. The dynamic module may be configured to determine the charging and discharging status of the plurality of power packs and batteries or other energy storage units in real-time. For example, in one aspect, the dynamic module may help govern bidirectional charge/discharge in real-time. The electric charge may flow from the ESU into the plurality of power packs and batteries or other energy storage units or vice versa.

### Configuration Module

The ECS may comprise a configuration module configured to determine any change in the configuration of charged power packs from the charging module. For example, in one aspect, the configuration module may be provided to charge the configuration of the power packs, such as from series to parallel or vice versa. This may occur via communication with the charging/discharging hardware of the ESU.

### Identifier Module

The identifier module, described in more detail hereafter, identifies the charging or discharging requirement for each power pack to assist in best meeting the power supply needs of the device. This process may require access to the database information about the individual power packs from the energy source modules (e.g., a supercapacitor module) and information about the current state of the individual power packs provided by the sensors and charge and current detections circuits associated with the charging and discharging hardware, cooperating with the charge/discharge module and, as needed, with the dynamic module and the safety module.

### Safety Module

The sensors may communicate with the safety module to determine if the power packs and individual components show excessive local or system temperature signs that might harm the components. In such cases, the safety module interacts with the processor and other features (e.g., data stored in the databases of the cloud or memory pertaining to safe temperature characteristics for the ESU) to cause a change in operation such as decreasing the charging or discharging underway with the portions of the power packs or other units facing excessive temperature. The safety module may also regulate cooling systems that are part of the charging and discharging hardware to proactively increase the cooling of the power packs, batteries, or other energy storage units. Increasing the load on them does not lead to harmful temperature increases.

Thus, the safety module may also interact with the dynamic module in responding to forecasts of system demands in the near future for anticipatory control of the ESU for optimized power delivery. In the interaction with the dynamic module, the safety module may determine that an upcoming episode of high system demand such as imminent climbing of a hill may impose excessive demands on a power pack already operating at elevated temperature, and thus make a proactive recommendation to increase cooling on the at-risk power packs. Other sensors such as strain gauges, pressure gauges, chemical sensors, etc., may be provided to determine if any of the energy storage units in batteries or other energy storage units or the power packs are facing pressure buildup from outgassing, decomposition, corrosion, electrical shorts, unwanted chemical reactions such as an incipient runaway reaction, or other system difficulties. In such cases, the safety module may initiate precautionary or emergency procedures such as a shutdown, electrical isolation of the affected components, warnings to a system administrator via the communication module to the message center, a request for maintenance to the maintenance module.

### Maintenance Module

The maintenance module determines when the ESU requires maintenance, either per a predetermined scheduled or when needed due to apparent problems in performance, as may be flagged by the performance module, or in issues about safety as determined by the safety module based on data from sensors or the charging/discharging hardware, and in light of information from the energy sources modules. The maintenance module may cooperate with the communication module to provide relevant information to the display interface and the message center. An administrator or owner may initiate maintenance action in response to the message provided. The maintenance module may also initiate mitigating actions to be taken, such as cooperating with the charge/discharge module to decrease the demand on one or more of the power packs in need of maintenance and may also cooperate with the configuration module to reconfigure the power packs to reduce the demand in components that may be malfunctioning of near to malfunctioning to reduce harm and risk.

### Performance Module

The performance module continually monitors the results obtained with individual power packs and the batteries or other energy storage units and stores information as needed in memory and the cloud databases or via messages to the message center. The monitoring is done through the use of the sensors and the charging/discharging hardware, etc. The tracking of performance attributes of the respective energy sources can guide knowledge about the system's health, the capabilities of the components, etc., which can guide decisions about charging and discharging in cooperation with the charge/discharge module. The performance module compares actual performance, such as power density, charge density, time to charge, thermal behavior, etc., to specifications and can then cooperate with the maintenance module to help determine if maintenance or replacement is needed, and alert an administrator via the communication module with a message to the message center about apparent problems in product quality.

### Security Module: Security and Anti-Counterfeiting Measures

The security module helps reduce the risk of counterfeit products or theft or misuse of legitimate products associated with the ESU, thus including one or more methods for authenticating the nature of the ESU and authorization to use it with the device in question. Methods of reducing the risk of theft or unauthorized use of an ESU or its respective power packs can include locks integrated with the casing of the ESU that mechanically secure the ESU in the electric vehicle or other devices, wherein a key, a unique fob, a biometric signal such as a fingerprint or voice recognition system, or other security-related credentials or may be required to enable removal of the ESU or even operation thereof.

In another aspect, the ESU comprises a unique identifier (not shown) that can be tracked, allowing a security system to verify that a given ESU is authorized for use with the device, such as an electric vehicle or other devices. For example, the casing of the ESU or one or more power packs therein may have a unique identifier attached, such as an RFID tag with a serial number (an active or passive tag), a holographic tag with unique characteristics equivalent to a serial number or password, nanoparticle markings that convey a unique signal, etc. One good security tool that may be adapted for the security of the ESU is a seemingly ordinary bar code or QR code with unique characteristics not visible to the human eye that cannot be readily copied, is the Unisecure™ technology offered by Systech (Princeton, N.J.), a subsidiary of Markem-Image, that essentially allows ordinary QR codes and barcodes to become unique, individual codes by analysis of tiny imperfections in the printing to uniquely and robustly identify every individual product, even if it seems that the same code is printed on every one.

Yet another approach relies at least in part on the unique electronic signature of the ESU and one or more individual power packs or of one or more supercapacitor units therein. The principle will be described relative to an individual power pack but may be adapted to an individual supercapacitor or collectively to the ESU as a whole. When a power pack comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack may then be tested using any suitable tool capable of identifying a signature specific to the individual power pack.

### Communication Module

The communication module can govern communications between the ECS and the outside world, including communications through the cloud, such as making queries and receiving data from various external databases or sending messages to a message center where they may be processed and archived by an administrator, a device owner, the device user, the ESU owner, or automated systems. In some aspects, the communication module may also oversee communication between modules or between the ESU and the ECS and work in cooperation with various modules to direct information to and from the display interface. Communications within a vehicle or between the ECS or ESU and the device may involve a DC bus or other means such as separate wiring. Any suitable protocol may be used, including UART, LIN (or DC-LIN), CAN, SPI, I2C (including Intel's SMBus), and DMX (e.g., DMX512). In general, communications from the ECS or ESU with a device may be over a DC bus or, if needed, over an AC/DC bus, or by separately wired pathways if desired, or wireless.

Communication to the cloud may occur via the communication module and may involve wired or wireless connections. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an energy storage unit can be conducted based on measurements made with the charging/discharging hardware in communication with specific modules of the ECS. In general, an electrostatic module can manage the measurement of charge and processing of the data.

The electrostatic module may be configured to identify the power pack type and the capacity of each power pack connected to the modular multi-type power pack energy storage unit. Further, the electrostatic module may be configured to retrieve information related to the type of power packs from the charging database. The electrostatic module may determine the capacity of each power pack to be charged. It may be configured to determine the capacity of each power pack when connected to the modular multi-type power pack ESU.

The electrostatic module may be configured to determine if each power pack charged below the threshold limit. For example, in one aspect, the electrostatic module may check whether each of the plurality of power packs may have a capacity below the threshold limit. The electrostatic module may also be configured to send data related to power packs to the ECS.

### Various Databases

The ECS may access various databases via an interface to the cloud and store retrieved information in the memory to guide the various modules.

Further, the memory may comprise a charging database or information from such a database obtained from the databases or the cloud. In one aspect, the charging database may be configured to store information related to various power packs used while charging and discharging from the ESU. In one aspect, the charging database may be configured to store information related to the power cycle of each of the plurality of power packs, the maximum and minimum charge for different types of power packs, and the state of charge (SoC) profile of each of the plurality of power packs.

The charging database may be configured to store information related to managing the plurality of power packs, such as the type of power pack to be charged, safety specifications, recent performance data, bidirectional charging requirements, or history of each of the plurality of power packs, etc. In another aspect, the stored information may also include, but is not limited to, the capacity of each of the plurality of power packs, amount of charge required for one trip of the electric vehicle along the path, such as golf course, etc., charging required for a supercapacitor unit, etc. In another aspect, the charging database may provide a detailed research report for the electric vehicle's average electric charge consumption over a path. In one aspect, the charging database may be configured to store information of the consumption of the electric charge per unit per kilometer drive of the electric vehicle from the plurality of power packs. For example, such information may indicate that a golf cart is equipped with five supercapacitor-driven power packs each at 90% charge, with each power packable to supply a specified amount of ampere-hours (Ah) of electric charge resulting in an ability to drive under normal conditions at top speed for, say, 80 kilometers. The information may also indicate that a solar cell installed on the roof of the golf cart would, under current partly clouded conditions, still provide enough additional charge over the planned period of use to extend the capacity of the ESU by another 40 kilometers for one passenger.

The performance module may use the charging database to read data and store new data on the individual energy storage units such as the power packs.

### Power Pack

A power pack is a unit that can store and deliver charge within an energy storage unit and comprises one or more supercapacitors such as supercapacitors in series and parallel. It may further comprise or cooperate with temperature sensors, charge and current sensors (circuits or other devices), connectors, switches such as crosspoint switches, safety devices, and control systems such as charge and discharge control systems. In various aspects described herein, the power pack may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack may have a functional temperature range from −70° C. to +° C., such as from −50° C. to ° C. or from −40° C. to 80° C. The voltage provided by the power pack may be any practical value such as 3V or more significant, such as from 3V to 240 V, 4V to 120 V, etc.

By way of example, a power pack may comprise one or more units, each comprising at least one supercapacitor having a nominal voltage from 2 to 12 V, such as from 3 to 6 V, including supercapacitors rated at about 3, 3.5, 4, 4.2, 4.5, and 5 V. For example, in discharge testing, a power pack was provided and tested with 14 capacitors in series and five series in parallel charged with 21,000 F at 4.2 V and had 68-75 Wh. Power packs may be packaged in protective casings that can easily be removed from an ESU and replaced. They may also comprise connectors for charging and discharging. Power packs may be provided with generally rectilinear casings, or they may have cylindrical or other useful shapes.

### Supercapacitor Information

### Supercapacitors

A supercapacitor may have two electrode layers separated by an electrode separator wherein each electrode layer is electrically connected to a current collector supported upon an inert substrate layer; further comprising an electrolyte-impervious layer disposed between each electrode layer and each conducting layer to protect the conducting layer, and a liquid electrolyte disposed within the area occupied by the active electrode layers and the electrode separator. To inhibit electrolyte flow, the liquid electrolyte may be an ionic liquid electrolyte gelled by a silica gellant or other gellant.

The supercapacitor may comprise an electrode plate, an isolation film, a pole, and a shell. The electrode plate comprises a current collector, and a coating is disposed of on the current collector. The coating may comprise an active material that may include carbon nanomaterial such as graphene or carbon nanotubes, including nitrogen-doped graphene, a carbon nitride, carbon materials doped with a sulfur compound such as thiophene or poly 3-hexylthiophene, etc., or graphene on which is deposited nanoparticles of metal oxide such as manganese dioxide. The coating may further comprise a conductive polymer such as one or more polyaniline, polythiophene, and polypyrrole. Such polymers may be doped with various substances such as boron (especially in the case of polyaniline).

Electrodes in supercapacitors may have thin coatings in electrical communication with a current collector, to provide high electrode surface area for high performance, electrodes may comprise porous material with a high specific surface area such as graphene, graphene oxide, or various derivatives of graphene, carbon nanotubes or other carbon nanomaterials including activated carbon, nitrogen-doped graphene or another doped graphene, graphite, carbon fiber-cloth, carbide-derived carbon, carbon aerogel. They may comprise various metal oxides such as oxides of manganese, etc. All such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors about charge state, temperature, and other performance and safety aspects. An actuation mechanism may be integrated to prevent undesired discharge.

The voltage of an individual supercapacitor may be greater than 2 V, such as from 2.5 V to 5 V, 2.7 V to 8 V, 2.5 V to 4.5 V, etc.

Supercapacitors can be divided into units of smaller supercapacitors. In one embodiment, a “constant voltage unit” of five units can be joined together in parallel to maintain the voltage but supply five times more current. In another embodiment, a “constant current unity” can include five units joined together in series to multiply the unit voltage by five times but maintain the current. In another embodiment, supercapacitors can provide hybrid “constant voltage units” and “constant current units.” In yet another embodiment, supercapacitors units can be connected in any number of combinations to end up with a supercapacitor of optimum design. In another embodiment, each supercapacitor unit can comprise various subunits or pouches. Supercapacitor subunits can be combined for a super capacitor using constant current sub units or constant voltage sub units, or any combination. In yet another embodiment, supercapacitor units or sub-units can comprise and size or form factor. In yet another embodiment, each subunit and unit can be uniquely addressed to turn on or off the super capacitor unit or sub-unit on or off. This is achieved with any variety of crossbar switches. A crossbar switch is an assembly of individual switches between inputs and a set of outputs. The switches are arranged in a matrix. If the crossbar switch has M inputs and N outputs, then a crossbar has a matrix with M×N cross-points or places where the connections cross. At each crosspoint is a switch; when closed, it connects one of the inputs to one of the outputs. A given crossbar is a single layer, non-blocking switch. A non-blocking switch means that other concurrent connections do not prevent connecting other inputs to other outputs. Collections of crossbars can be used to implement multiple layers and blocking switches. A crossbar switching system is also called a coordinate switching system. In this way, a crossbar switch can select any combinations of pouches or subunits and units to obtain any combination. The crossbar switches can be used for testing units or subunits as well as optimizing supercapacitor performance.

### Powered Devices and Electric Vehicles, Etc.

Powered devices powered by the ESU can include electric vehicles and other transportation devices of all kinds, such as those for land, water, or air, whether adapted to operate without passengers or with one or more passengers. Electric vehicles may include automobiles, trucks, vans, forklifts, carts such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like, etc. The electric vehicle generally comprises one or more motors connected to the ESU and an energy control system (ECS) that controls the power delivered from the ESU and may comprise a user interface that provides information and control regarding the delivery of power from the ESU as well as information regarding performance, remaining charge, safety, maintenance, security, etc. Not all transportation devices require non-stationary motors. An elevator, for example, may have a substantially stationary motor while the cabin moves between the level of a structure. Other transport systems with mobile cabins, seats, or walkways may be driven by stationary motors driving cables, chains, gears, bands, etc.

Apart from electric vehicles, there are many other devices that the ESU may power in cooperation with the ESC. Such other devices can include generators, which in turn can power an endless list of electric devices in households and industry. ESUs of various sizes and shapes can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the powered device is the grid, and in such versions, the ESU may comprise an inverter to turn DC into AC suitable for the grid.

In some aspects, a plurality of devices such as electric vehicles may be networked together via a cloud-based network, wherein the devices share information among themselves and with a central message center such that an administrator can assist in managing the allocation of resources, oversee maintenance, evaluate the performance of vehicles and ESUs, upgrade software or firmware associated with the ESC to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU may comprise both power packs and one or more lead-acid batteries or other batteries. The ESU may power both the motor as well as the onboard power supply system. The display interface of the associated ESC may comprise a graphical user interface such as the vehicle's control panel (e.g., a touch panel). The display interface may also comprise audio information and verbal input from a user.

### Motors

The ESU may power any electric motor. The major classes of electric motors are: 1) DC motors, such as series, shunt, compound wound, separately excited (wherein the connection of stator and rotor is made using a different power supply for each), brushless, and PMDC (permanent magnet DC) motors, 2) AC motors such as synchronous, asynchronous, and induction motors (sometimes also called asynchronous motors), and 3) special purpose motors such as servo, stepper, linear induction, hysteresis, universal (a series-wound electric motor that can operate on AC and DC power), and reluctance motors.

### Display Interface

The display interface of the ESC may be displayed on or in the device, such as on a touch screen or other display in a vehicle or on the device, or it may be displayed by a separate device such as the user's phone. The display interface may comprise or be part of a graphic user interface such as the vehicle's control panel (e.g., a touch panel). The display interface may also comprise audio information and verbal input from a user. It may also be displayed on the ESU itself or a surface connected to or communicated with the ESU. In one version, the display interface may include but is not limited to a video monitoring display, a smartphone, a tablet, and the like, each capable of displaying a variety of parameters and interactive controls. Still, the display could also be as simple as one or more lights indicating charging or discharging status and optionally one or more digital or analog indicators showing remaining useful lifetime, % power remaining, voltage, etc.

Further, the display interface may be any state-of-the-art display means without departing from the scope of the disclosure. In some aspects, the display interface provides graphical information on charge status, including one or more fractions of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in the rain, underwater, indoors, etc.). Selections may be made through menus and buttons on a visual display, through audio “display” of information responsive to verbal commands, or through text commands or displays transmitted to a phone or computer, including text messages or visual display via an app or web page.

Thus, the ESU may comprise a display interface coupled to the processor to continuously display the status of charging and discharging the plurality of power packs.

### General:

All patents and applications cited must be understood as being incorporated by reference to the degree they are compatible.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to ° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating all its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

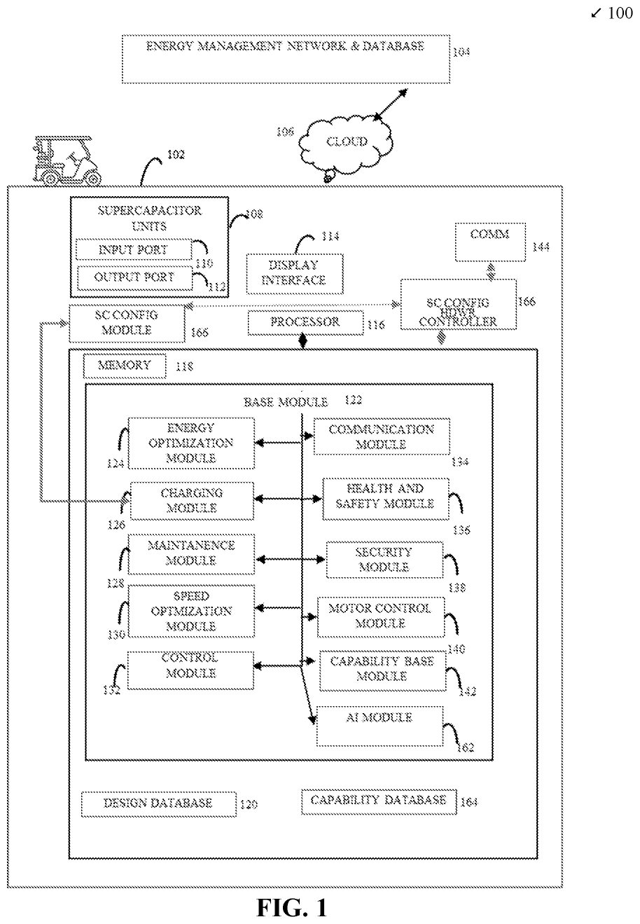

FIG. 1 is a block diagram illustrating an architecture of an energy management system 100. The energy management system 100 may be configured for a Supercapacitor battery powered Electronic Vehicle. The energy management system 100 may comprise the electric vehicle 102. In one embodiment, the electric vehicle 102 may correspond to but is not limited to a golf cart, an electric car, and an electric bike. In one embodiment, the energy management system 100 may be referred to as a system for enhancing the capability of the electric vehicle 102 using ultra-capacitors or supercapacitors in series or parallel. Further, the energy management system 100 may provide a smart energy management system to supply electric charge to the vehicle motor of the electric vehicle 102 from supercapacitors in a controlled manner to maximize charge efficiency. Further, the energy management system 100 may provide ultra-capacitors with real-time charging and discharging while the electric vehicle 102 is continuously accelerating and decelerating along a predefined path. In one embodiment, the energy management system 100 may be referred to as a modular graphene supercapacitor power pack for powering the electric vehicle 102, in electric vehicle 102. Further, the energy management system 100 may comprise an energy management database 104 communicatively coupled to the electric vehicle 102 via a cloud 106 or directly to the processor (not shown).

In one embodiment, the energy management database 104 may be configured to provide historical data related to the electric vehicle 102. In another embodiment, the energy management database 104 may provide a research report for an average charge consumption of the electric vehicle 102 over a predefined path. In one embodiment, the energy management database 104 may store information related to supercapacitor units, electric charge percentage, acceleration of motor, and electric charge in the supercapacitor units, as well as data for individual drivers, driving conditions (temperature, weather, time of year or day), power pack identity or characteristics, the mass of the vehicle and passengers and cargo (this may require load cells installed in the vehicle or an external device for weighing the vehicle), etc., in energy management database 104. Further, embodiments may include a cloud 106. It can be noted that cloud 106 may facilitate a communication link among the components of the energy management system 100. It can be noted that cloud 106 may be a wired and a wireless network. The cloud 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. In some embodiments, the cloud connection could be replaced by a “bus” to connect the processor to any other controller or memory unit (not shown) in cloud 106. Further, the energy management system 100 may comprise a plurality of supercapacitor units 108 disposed within the electric vehicle 102.

Unit 108 could be, for example, is a 21,000 F 4.2V nano-pouch graphene energy module with a final 48V 100 AH Graphene Power Pack. The 21,000 F 4.2V nano-pouch graphene energy modules may contain many layers of a graphene lattice matrix structure deposited using a unique method of electropolymerization that provides a highly dense energy storage module design with high-current energy transfer. Due to the tightly coupled nanotechnology design and manufacturing methods, energy storage and delivery can be cycled thousands of times without matrix degradation. This power pack is a capacitive battery substitute in nature, graphene-based, and contains no lithium or other chemical conversion components. In one embodiment, the plurality of supercapacitor units 108 may be continuously charged in real-time, depending upon the usage of the electric vehicle 102, such as through the use of solar panels, inductive charging, etc., and optionally by redistributing charge among individual supercapacitors or supercapacitor units (a single supercapacitor unit 108 may comprise multiple supercapacitors internally). Alternatively or in addition, supercapacitor units 108 may be charged while connected to a suitable charging source such as an AC power line (not shown) or DC power (not shown) n alternative energy source such as solar power, wind power, etc., where a trickle charging system may be applied, in supercapacitor units 108.

Further, the plurality of supercapacitor units 108 may comprise an input port 110 and an output port 112. Further, the input port 110 may be provided to charge the plurality of supercapacitor units 108. The output port 112 may be provided to connect the plurality of supercapacitor units 108 to the electric vehicle 102 or any other device. Input port 110 and output port 112 may be used for testing the supercapacitor unit 108 (not shown) in input port 110. In one embodiment, the output port 112 may be provided with a connector to connect the plurality of supercapacitor units 108 to the electric vehicle 102. In one embodiment, each of the plurality of supercapacitor units 108 may comprise a plurality of power pack units coupled to each other in series or parallel.

In one embodiment, the plurality of supercapacitor units 108 may enhance the performance of the electric vehicle 102 by supplying the electric charge according to the desired need of the electric vehicle 102, in output port 112. Further, the charging and discharging of each of the plurality of supercapacitor units 108 may be displayed over a display interface 114 (not shown). In one embodiment, the display interface 114 may be integrated within the electric vehicle 102. The display interface 114 may be, but is not limited to, a video monitoring display, a smartphone, and a tablet, each capable of displaying a variety of parameters and interactive controls, but could also be as simple as one or more lights indicating charging or discharging status and optionally one or more digital or analog indicators showing remaining useful lifetime, % power remaining, voltage, etc. It should be noted that instructions related to managing the plurality of supercapacitor units 108 may be stored in the energy management database 104.

Further, a user may retrieve the store instructions from the energy management database 104 before driving the electric vehicle 102. In one embodiment, the stored instructions may include but are not limited to the capacity of each of the plurality of supercapacitor units 108, amount of charge required for one trip of electric vehicle 102 along the path, such as golf course, etc., charging required for a supercapacitor unit, and acceleration and deceleration data related to the path of the electric vehicle 102. The energy management database 104 need not comprise details about the route and its characteristics. Still, it may interact with a GPS, terrain database, or other sources of information (not shown) to enable the needed computations in display interface 114. Further, the energy management system 100 may be operatively associated with a processor 116, a memory unit 118, and a design database 120. In one embodiment, the processor 116 may be comprised within the electric vehicle 102 or integrated within the casing or other components of the energy management system 100 or may have components distributed in two or more locations.

Further, processor 116 may be configured to retrieve the electric vehicle 102, the plurality of supercapacitor units 108 from the energy management database 104, the terrain or route, and other parameters via the cloud 106 and other remote sources. In one embodiment, the retrieved information related to the electric vehicle 102 may be stored in real-time into the memory unit 118, an processor 116. Further, the memory unit 118 may be configured to retrieve information related to the performance of the electric vehicle 102 from the design database 120, in memory unit 118. In one embodiment, the design database 120 may be configured to store the consumption of electric charge per unit per kilometer drive of the electric vehicle 102. For example, an electric vehicle 1 with ten supercapacitor units installed consumes 5 kW/h of electric charge for one hour to drive the electric vehicle 1 for a distance of one kilometer at a characteristic speed of 7 m/s (about 16 mph) with an initial acceleration of, say, 23M/s2. Further, for an electric vehicle 2 with 15 supercapacitor units installed, it consumes 8 kW/h of electric charge for one hour to drive the electric vehicle 2 for a distance of one kilometer with an acceleration of 42 m/s2. Further, for an electric vehicle 3 with 13 supercapacitor units installed, it consumes 4 kW/h of electric charge for one hour to drive the electric vehicle 3 for a distance of one kilometer with an acceleration of 26 m/s2. Further, for an electric vehicle 4 with 12 supercapacitor units installed, it consumes 3 kW/h of electric charge for one hour to drive the electric vehicle 4 for a distance of one kilometer with an acceleration of 24 m/s2. Further, for an electric vehicle 5 with 20 supercapacitor units installed, it consumes 10 kW/h of electric charge for one hour to drive the electric vehicle 5 for a distance of one kilometer with an acceleration of 46 m/s2, in design database 120.

Further, the energy management system 100 may comprise a plurality of modules to evaluate and enhance the performance of the electric vehicle 102. In one embodiment, the energy management system 100 may comprise or be operatively associated with a base module 122 communicatively coupled to the processor 116. In another embodiment, base module 122 may reside in whole or in part in memory 118. In one embodiment, the base module 122 may act as a central module to receive and send instructions to/from each of the plurality of modules. In one embodiment, the base module 122 may be configured to manage at least two parameters related to the electric vehicle 102, such as, but are not limited to, electric charge of the plurality of supercapacitor units 108 and the performance of the electric vehicle 102 when the electric vehicle 102 receives a predefined amount of electric charge from the plurality of supercapacitor units 108, in base module 122.

Further, the base module 122 may comprise an energy optimization module 124 to optimize the electric charge of the plurality of supercapacitor units 108. In one embodiment, the energy optimization module 124 may be configured to determine the percentage of electric charge available in each of the plurality of supercapacitor units 108. In another embodiment, the energy optimization module 124 may be configured to collect data related to each of the plurality of supercapacitor units 108 required for one run time of the electric vehicle 102 along the predefined path. The Energy Optimization Module 124 is designed to rely on supercapacitors' premeasure performance, such as the charge curve over time and the discharge curve overtime at various loads. Once this premeasured performance is defined, it is stored in a database (not shown). The Energy Optimization Module 124 may also rely on other curves such as, but not related to voltage vs. current charge and discharge curves, temperature as a discharge function under various loads, humidity versus storage time as a particular voltage, etc. The Energy Optimization module may, for example, evaluate the future load prediction due to a user-defined map, where the energy optimization module 124 may determine that 5 out of 10 batteries would be sufficient for the prediction, so the energy optimization module 124 determinations may inform which batteries may be used for the predicted trip. The energy optimization module 124, using suer capacitor premeasurements, may determine that even though 5 out of 10 batteries would be sufficient for the preplanned trip, that 7 of the ten supercapacitor batteries are used, leaving 7 of 10 batteries with usable future charge and 3 of the ten batteries left fully charges in case there is a deviation from the planned trip. The energy optimization module 124 could define used in preplanned route optimization or route optimization in many ways, including but not limited to Artificial Intelligence of historical data, historical data on actual use of a common route, etc. Since graphene-based supercapacitors have unique “signatures of performance” based upon pre measurements above that are different than, say, lead-acid batteries or lithium-ion batteries, the unique “signatures of performance” using the energy optimization module 124 will make the driving experience of the EV using the graphene-based supercapacitors to be a least the same if not better experience than if the EV used lead-acid batteries or lithium-ion batteries, that is, less likely to have battery failures, batteries lose power uphill, batteries run out when traveling, in energy optimization module 124.

Further, the base module 122 may comprise a charging module 126, configured to evaluate the charging requirement of each of the plurality of supercapacitor units 108. The charging module 126 may be activated and deactivated automatically by the base module 122 upon receiving a request from the energy optimization module 124 related to the requirement of the electric charge to drive the electric vehicle 102. For example, if there are enough battery units with enough charge for running the EV at certain speeds for a certain amount of time (average power consumption), the charging module 126 is deactivated. If the EV at certain speeds for a certain time (average power consumption) is not available, the charging module 126 is activated. In one embodiment, the charging module 126 may be configured to retrieve data related to each of the plurality of supercapacitor units 108 from the energy management database 104. In one embodiment, the data related to each of the plurality of the supercapacitor units 108 may correspond to an amount of electric charge stored in each of the plurality of supercapacitor units 108. In another embodiment, the charging module 126 may be configured to analyze and compare the data retrieved from the energy management database 104 concerning the data related to each of the plurality of supercapacitor units 108. Further, the charging module 126 may determine whether charging is needed or not. in charging module 126.

Further, the base module 122 may comprise a maintenance module 128 to maintain the electric vehicle 102. In one embodiment, the maintenance module 128 may be configured to run internal maintenance of the electric vehicle 102 and the plurality of supercapacitor units 108 after the base module 122 receives a notification from the charging module 126. Further, the maintenance module 128 may determine whether the electric vehicle 102 is consuming the electric charge more than the desired charge for a particular run time, where a maintenance check may be needed. In one embodiment, the maintenance module 128 may raise a maintenance request to the base module 122, indicating that the plurality of supercapacitor units 108 is not coupled correctly. The electric vehicle 102 is experiencing more load while driving over the predefined path. Further, the maintenance module 128 may determine the performance of the electric vehicle 102 for retrieved performance from the design database 120 and the energy management database 104. In another embodiment, the maintenance module 128 may perform an internal maintenance check-up to determine whether each component of the electric vehicle 102 is functioning up to its desired requirement in maintenance module 128.

Further, the base module 122 may comprise a speed optimization module 130 configured to provide the predefined path of the electric vehicle 102. The speed optimization module 130 may also be referred to as a range optimization module in one embodiment. Further, the speed optimization module 130 may enhance the performance of the electric vehicle 102 by minimizing the consumption of electric charge. In one embodiment, the speed optimization module 130 may be configured to provide a road map for the electric vehicle 102. In one embodiment, the road map may be a graph or a curve with anticipated acceleration and deceleration points along the predefined path with areas where the drain is used and where it is not (hills drain batteries a lot and valleys drain the battery less). Therefore, the electric vehicle 102 may consume electric charge only when accelerating over a steep curve and may stop the flow of the electric charge while moving downwards on a steep curve. Further, the speed optimization module 130 may retrieve information related to maintenance of the electric vehicle 102 from the design database 120 to measure the amount of electric charge consumed by the electric vehicle 102 before maintenance in speed optimization module 130.

Further, the base module 122 may comprise a control module 132 configured to determine the best use of the electric charge from the plurality of supercapacitor units 108. In one embodiment, the controller module 132 may be configured to retrieve information related to the ideal consumption of the electric charge of the electric vehicle 102 from the energy management database 104. Further, the controller module 132 may use information from the energy optimization module 124, the charging module 126, the maintenance module 128, and the speed optimization module 130 to determine the best use of the electric charge. For example, the controller module 132 retrieves from the energy management database 104 that the electric vehicle 102 should consume 3 kWh per kilometer of electric charge. However, the maintenance module 128 and the speed optimization module 130 provide information that the electric vehicle 102 is consuming 4 kWh per kilometer of electric charge. Therefore, the controller module 132, using the anticipated acceleration and deceleration map, can determine the best use of the electric charge to manage overall watt-hour energy over time. Further, the controller module 132 may be configured to effectively manage the plurality of supercapacitor units 108 in series or parallel in controller module 132.

In one embodiment, the base module 122 may comprise a communication module 134 configured to facilitate communication between the base module 122 and the plurality of supercapacitor units 108. Further, the base module 122 may determine the number of supercapacitor units being used in the electric vehicle 102 in real-time. In one embodiment, the communication module 134 may be configured to provide an exact figure for connections of the supercapacitor units 108 for the plurality of supercapacitor units 108, which continuously supply electric charge to the electric vehicle 102. Further, the base module 122 may comprise a health and safety module 136 and a security module 138. The health and safety module 136 may be configured to provide health and safety-related to the user related to the safety of the battery (danger of fire or explosion) of the electric vehicle 102. For example, 102 experiences health-related problems while driving the electric vehicle, such as batteries getting near and an over-temperature setting, which can be displayed using the display interface 114. Further, the electric vehicle 102 may be provided with the security module 138 to measure continuously the plurality of supercapacitor units 108 installed within the electric vehicle 102. The security module 138 may also evaluate and warn users how external charging hookups may be configured. Communications module 134 covers internal messaging and control data internally to the system 100 and messaging to the user using the display interface 114, in communications module 134. Further, the base module 122 may comprise a health and safety module 136. The health and safety module 136 may be configured to provide health and safety-related to the user related to the safety of the battery (danger of fire or explosion) of the electric vehicle 102, in safety module 136. Further, the electric vehicle 102 may be provided with the security module 138 to measure continuously the plurality of supercapacitor units 108 installed within the electric vehicle 102. The security module 138 may also evaluate and warn users how external charging hookups may be configured in security module 138. Further, the base module 122 may comprise a motor control module 140 to enhance the performance of the vehicle motor of the electric vehicle 102. In one embodiment, the motor control module 140 may be configured to evaluate the performance of the vehicle motor in at least two modes. In one embodiment, the two modes may be an enhanced torque mode and an economy mode. Further, the enhanced torque mode may be employed when the electric vehicle 102 moves up a hill or the steep curve of the road upwards. In one embodiment, the motor consumes more electric charge to generate more torque for moving the electric vehicle 102 upwards. Further, the economy mode may be initiated when the electric vehicle 102 moves down the hill. The less electric charge needs to drive the electric vehicle 102 downwards or when the electric vehicle 102 is extending beyond the run time. In one embodiment, the motor control module 140 may be configured to monitor and anticipate the performance of the motor according to the enhanced torque mode or the economy mode. Further, the motor control module 140 may retrieve data related to parameters affecting the movement of the electric vehicle 102 over the path from the energy management database 104 and the design database 120. In one embodiment, the data may include but is not limited to weather, length of the day, length of a golf course, an motor control module 140.

The capability base module 142 executes the Testing Capability Module 144, then executes the Range Compute Module 150, then executes the Capacity Compute Module 156, and (Optionally) executes AI Module 162, then reads all Metadata for current data then displays all Metadata for current data on the display interface 114. It should also be noted that the Capability Base Module 142 is integrated with all the base module 122 sub-modules as the range and capacity and AI data may inform (not shown) how energy is optimized, charging is optimized, Maintenance is optimized, speed is optimized, and health and safety are optimized, at capability base module 142.

The Testing Capability Module 144 executes Testing History Module 146 and then executes Testing Current Module 148, at Testing Capability Module 144. The Testing History Module 146 connects to the SC Config HDWR Controller 168 to access SC Config Module 166. The Testing History Module 146 reads Testing History Data from the SC Config Module 166, related to Range Data or Capacity Data, at Testing History Module 146. The Testing Current Module 148 inputs all data from the Capability Database 164 and then gets capability data from the SC Config Module 166 through the SC Config HDR Controller 168. In some embodiments, capability data could mean the current range the electric vehicle has traveled. In some embodiments, the capability could mean capacity (amp-hrs) used, by time, for electric vehicle current travel, at Testing Current Module 148. The Range Compute Module 150 executes the Range History Module 152 and executes Range Current Module 154, at Range Compute Module 150. The Range History Module 152 uses all the data in the Capability Database 164 to determine the range of the electric vehicle 102. In some embodiments, the Range History could be a range determined from history that appears to be a flat terrain where the use of the supercapacitor is easily projected by distance (mile, etc.). In some embodiments, the range determined from history appears to be a rugged terrain where it would be difficult to project the use of the supercapacitor by distance (miles, etc.) at output interface 152.

The Range Current Module 154 executes inputs all data from the Capacity Database 164. The Range Current Module 154 uses all the Capability Database 164 to determine the range of the electric vehicle 102, at Range Current Module 154. The Capacity Compute Module 156 executes the Capacity History Module 158 and the Capacity Compute Module 156, at Capacity Compute Module 156. The Capacity History Module 158 inputs all data from Capability database 164 to determine the capacity (amps Hrs) of the electric vehicle 102. In some embodiments, the Capacity History could be determined from history. The supercapacitor unit 108 appears to be a “linear use case” of capacity where the future capacity could be easily projected; that is, the time left for a given amperage can be predicted. In some embodiments, the Capacity determined from history may appear to be very nonlinear, and it would not be easy to project the supercapacitor unit 108 capacity.

It should be noted that many parameters can affect capacity, such as load in the vehicle, wind resistance, mechanical wear, etc., at Capacity History Module 158. The Capacity Current Module 160 inputs all data from the Capacity Database to determine the capacity of the electric vehicle 102. In some embodiments, the Current Capacity could be a capacity determined from history that appears to be linear. The use of the supercapacitor is easily projected in the time left on the current amperage. For example, the calculation could evaluate the capacity used on the current trip. This capacity could be used to find the time left at the current amperage taking into account the overall supercapacitor capacity subtracted from the capacity used already. If the capacity used is linear, metadata is also created, such as “Linear capacity used and Capacity prediction is highly accurate” In some embodiments, the capacity determined from history appears to be non-linear. If this is found, capacity cannot be easily predicted, and metadata such as “Capacity use variable—capacity cannot be predicted” is determined.

It should be noted that other types of calculation could be performed, such as (1) using a snapshot of historical data to determine if the capacity can be calculated or (2) using a moving average of historical data or others. It should also be noted that most electric vehicle 102 require a specific voltage range to operate, wherein the number of supercapacitors in series sets the voltage range. Complex supercapacitor systems (not shown) could swap in and out supercapacitor units to maintain voltage as supercapacitor units voltages change. Capacity is determined by the number of supercapacitor units in parallel. Complex supercapacitor systems (not shown) could swap in and out supercapacitor units to maintain capacitors as supercapacitor units' capacity changes. The Capacity Current Module 160 stores all data to the Capability Database 164, at Capacity Current Module 160. AI Module 162 may be used if Range or Capacity are both not easily predicted. AI Module 162 may be used to double-check a prediction. AI Module 162 may also be used if Range is predictable and Capacity is not, or vice versa, at AI Module 162. Capability Database 164 (not shown) stores and retrieves all data used by Capability Base Module 142 (and their related sub-modules) SC Config Module 166 and SC Config HDWR Controller 168, at Capability Database 164. SC Config Module 166 reads and controls supercapacitors units 108 and communicates with SC Config HDWR Controller 168. Not shown, SC Config Module can read the supercapacitors energy, charge, Capacity, Range by time and stores all this data in the Capability Database 164 in real-time. Not shown, SC Config Module can control the swapping in or out of supercapacitor units 108 subunits to control capacity (current) and voltage, at SC Config Module 166. SC Config HDWR Controller 168 connects to Capability Base Module 142 and SC Config Module to pass data and controls back and forth between them. SC Config HDWR Controller 168 may have its memory of it may store or read data from Capability Database 142, at SC Config HDWR Controller 168.

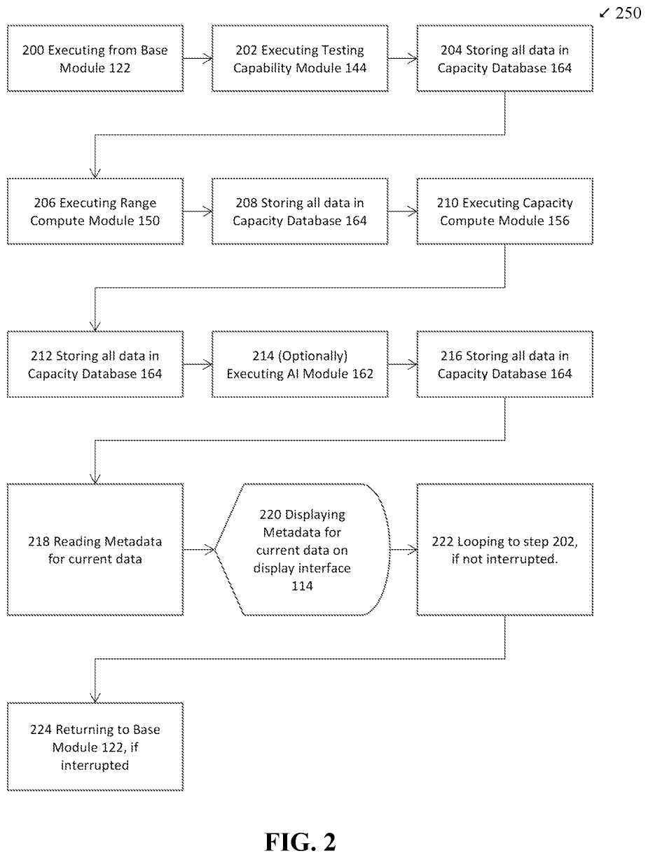

FIG. 2 is a flow diagram illustrating a process 250 performed using a capability base module. In FIG. 2, the capability base module 142 executes from Base Module 122 at operation 200. The capability base module 142 executes the Testing Capability Module 144 at operation 202. The capability base module 142 stores all data in Capacity Database 164, at operation 204. The capability base module 142 executes the Range Compute Module 150 at operation 206. The capability module 142 then stores all data in Capacity Database 164, at operation 208. The capability base module 142 then executes the Capacity Compute Module 156 at operation 210. The capability base module 142 stores all data in Capacity Database 164, at operation 212. (Optionally) The capability base module 142 then executes AI Module 162 at operation 214. The capability module 142 stores all data in Capacity Database 164, at operation 216. The capability module 142 reads all Metadata for current data at operation 218. The capability base module 142 then displays all Metadata for current data on the display interface 114. It should also be noted that the Capability Base Module 142 is integrated with all the base module 122 sub-modules as the range and capacity and AI data may inform (not shown) how energy is optimized, charging is optimized, Maintenance is optimized, speed is optimized, and health and safety are optimized, at operation 220. The capability base module 142 loops to operation 202, if not interrupted, at operation 222. The capability module 142 returns to Base Module 122, if interrupted, at operation 224.

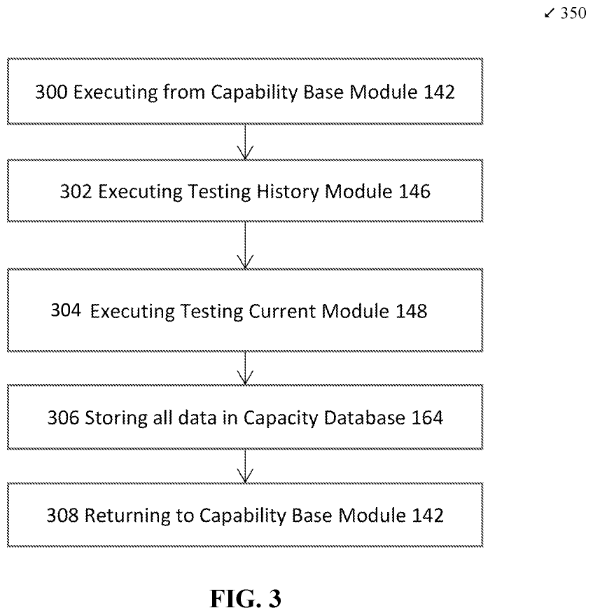

FIG. 3 is a flow diagram illustrating a process 350 performed using testing capability module. In FIG. 3, the process 350 begins with The Testing Capability Module 144 executes from Capability Base Module 142, at operation 300. The Testing Capability Module 144 executes Testing History Module 146 at operation 302. The Testing Capability Module 144 executes Testing Current Module 148 at operation 304. The Testing Capability Module 144 stores all data in Capacity Database 164, at operation 306. The Testing Capability Module 144 returns to Capability Base Module 142, at operation 308.

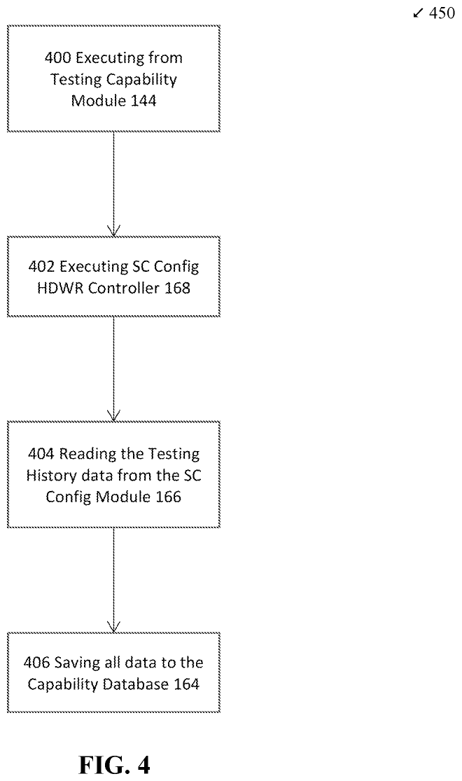

FIG. 4 is a flow diagram illustrating a process 450 performed using a testing history module. In FIG. 4, the Testing History Module 146 executes from Testing Capability Module 144, at operation 400. The Testing History Module 146 connects to the SC Config HDWR Controller 168 to access SC Config Module 166 at operation 402. The Testing History Module 146 reads Testing History Data from the SC Config Module 166. The Testing History data can be data collected from the design or manufacturing of the supercapacitor units 108. For example, the Testing History Data may be related to supercapacitors unit 108 related to Range Data or Capacity Data. For example, Range Data maybe, but is not limited to, the Range (in miles or KM) of the make and model of the current Electric Vehicle 102 at a particular speed on a flat roadway at a given outside temperature for no load to the electric vehicle. The Range data may be the Range (in miles or KM) of the make and model of the current Electric Vehicle 102 at a particular speed on a flat roadway at a given temperature for various loads (added weight to Electric Vehicle 102. The Range data may be the Range (in miles or KM) of the make and model of the current Electric Vehicle 102 at a particular speed on an average up and down terrain roadway at a given temperature for various loads (added weight to Electric Vehicle 102. The Range data may be the Range (in miles or KM) of the make and model of the current Electric Vehicle 102 at a particular speed on rugged terrain with lots of elevation changes in the roadway at a given temperature for various loads (added weight to Electric Vehicle 102. In another example, the Testing History Data may be related to supercapacitors unit 108 related to Capacity Data. For example, Battery's Capacity is the amount of electric charge the battery can deliver at the rated voltage.

The more electrode material contained in the cell, the greater it is Capacity. Although they develop the same open-circuit voltage, a small cell has less capacity than a larger cell with the same chemistry. Capacity is measured in units such as amp-hour (A·h). The rated capacity of a battery is usually expressed as the product of 20 hours multiplied by the current that a new battery can consistently supply for 20 hours at 68° F. (20° C.) while remaining above a specified terminal voltage per cell. For example, a battery rated at 100 A·h can deliver 4 A over 25 hours at room temperature. The fraction of the stored charge that a battery can deliver depends on multiple factors, including battery design, the rate at which the charge is delivered (current), the required terminal voltage, the storage period, ambient temperature, and other factors. Capacity Data maybe, but is not limited to, the Capacity of the make and model of the current Electric Vehicle 102 at a particular speed on a flat roadway at a given outside temperature for no load to the electric vehicle. The Capacity data may be the Capacity of the make and model of the current Electric Vehicle 102 at a particular speed on a flat roadway at a given temperature for various loads (added weight to Electric Vehicle 102. The Capacity data may be the Capacity of the make and model of the current Electric Vehicle 102 at a particular speed on an average up and down terrain roadway at a given temperature for various loads (added weight to Electric Vehicle 102. The Capacity data may be the Capacity of the make and model of the current Electric Vehicle 102 at a particular speed on rugged terrain with lots of elevation changes in the roadway at a given temperature for various loads (added weight) to Electric Vehicle 102.

It should be noted that given the voltage requirements are usually fixed to a tight voltage range, the supercapacitor unit 108 can be switched in series to maintain the voltage range needed. On the other hand, the Capacity is changed more dynamically and switched by adding more or fewer supercapacitor units 108 in parallel, at operation 404. The Testing History Module 146 saves all data to the Capability Database 164, at operation 406.

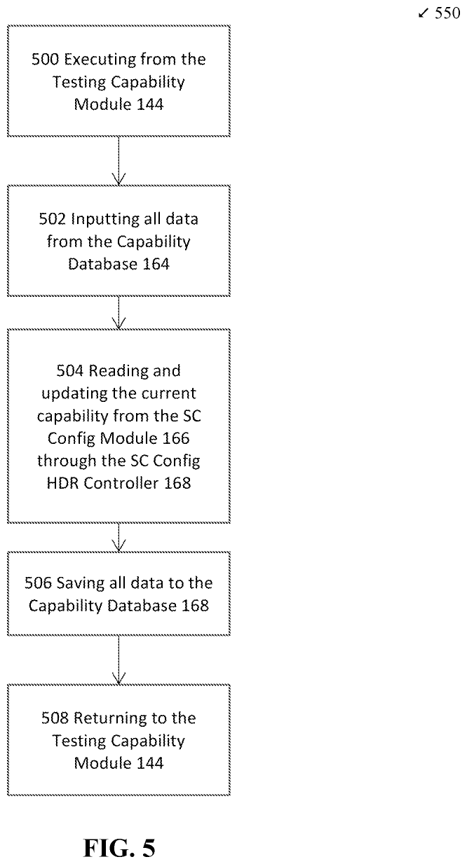

FIG. 5 is a flow diagram illustrating a process 550 performed using a testing current module. In FIG. 5, the Testing Current Module 148 executes from the Testing Capability Module 144, at operation 500. The Testing Current Module 148 inputs all data from the Capability Database 164, at operation 502. The Testing Current Module 148 gets capability data from the SC Config Module 166 through the SC Config HDR Controller 168. In some embodiments, capability data could mean the current range the electric vehicle has traveled. In some embodiments, the capability could mean capacity (amp-hrs) that has been used, by time, for electric vehicle current travel, at operation 504. The Testing Current Module 148 saves all data to the Capability Database 168, at operation 506. The Testing Current Module 148 returns to the Testing Capability Module 144, at operation 508.

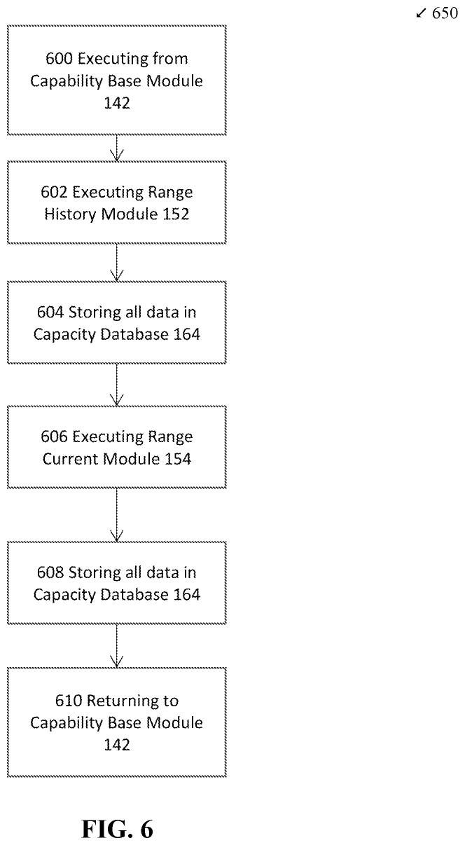

FIG. 6 is a flow diagram illustrating a process 650 performed using a range compute module. In FIG. 6, the Range Compute Module 150 executes from Capability Base Module 142, at operation 600. The Range Compute Module 150 executes the Range History Module 152 at operation 602. The Range Compute Module 150 stores all data in Capacity Database 164, at operation 604. The Range Compute Module 150 executes Range Current Module 154 at operation 606. The Range Compute Module 150 stores all data in Capacity Database 164, at operation 608. The Range Compute Module 150 returns to Capability Base Module 142, at operation 610.

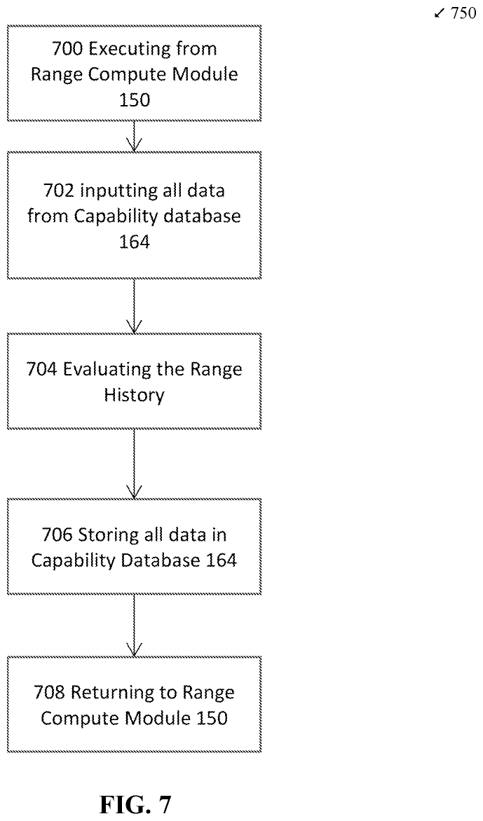

FIG. 7 is a flow diagram illustrating a process 750 performed using a range history module. In FIG. 7, the Range History Module 152 executes from Range Compute Module 150, at operation 700. The Range History Module 152 inputs all data from Capability database 164, at operation 702. The Range History Module 152 uses all the data in the Capability Database 164 to determine the range of the electric vehicle 102. In some embodiments, the Range History could be a range determined from history that appears to be a flat terrain where the use of the supercapacitor is easily projected by distance (mile, etc.). In some embodiments, the range determined from history appears to be a rugged terrain where it would be difficult to project the use of the supercapacitor by distance (miles, etc.) at operation 704. The Range History Module 152 stores all data in Capability Database 164, at operation 706. The Range History Module 152 returns to the Range Compute Module 150 at operation 708.

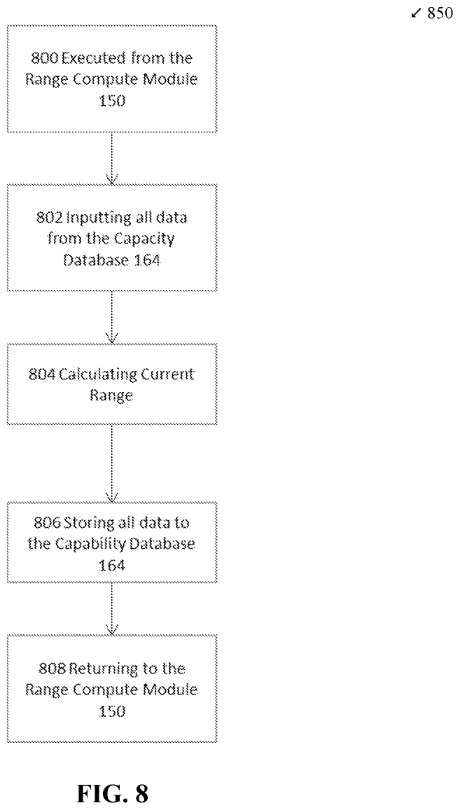

FIG. 8 is a flow diagram illustrating a process 850 performed using a range current module. In FIG. 8, the Range Current Module 154 executes from the Range Compute Module 150 at operation 800. The Range Current Module 154 inputs all data from the Capacity Database 164 at operation 802. The Range Current Module 154 uses all the data in the Capability Database 164 to determine the range of the electric vehicle 102. In some embodiments, the Current Range could be a range determined from history that appears to be a flat terrain where the use of the supercapacitor is easily projected by distance (mile, etc.). For example, the calculation could evaluate the distance driven on the current trip and the charge used. This ratio could be used to multiply the current charge available to predict this distance.

It should be noted that a flat terrain could be determined by a geolocation device that links to a map that has terrain data (not shown). Once it is determined that the terrain was relatively flat and that the prediction would be highly accurate if flat terrain continued, metadata is also created, such as “Terrain flat prediction is highly accurate” In some embodiments, the range determined from history appears to be a rugged terrain, again geolocation device that links to a map that has terrain data (not shown) where it would be difficult to project the use of the supercapacitor by distance (miles, etc.,). If this is found, distance is not predicted, and metadata such as “Terrain variable—range cannot be predicted” is determined. It should be noted that other types of calculation could be performed, such as (1) using a snapshot of historical data to determine if the range can be calculated or (2) using a moving average of historical data or other, at operation 804. The Range Current Module 154 stores all data to the Capability Database 164, at operation 806. The Range Current Module 154 returns to the Range Compute Module 150 at operation 808.

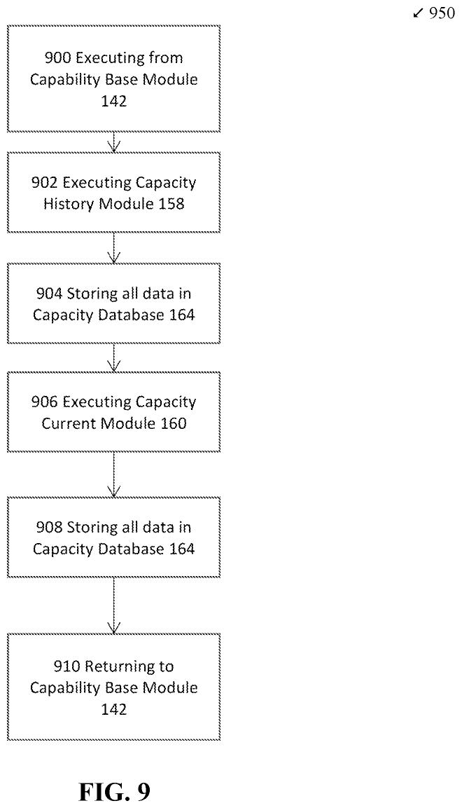

FIG. 9 is a flow diagram illustrating a process 950 performed using a capacity compute module. In FIG. 9, the Capacity Compute Module 156 executes from Capability Base Module 142, at operation 900. The Capacity Compute Module 156 executes Capacity History Module 158 at operation 902. The Capacity Compute Module 156 stores all data in Capacity Database 164, at operation 904. The Capacity Compute Module 156 executes Capacity Current Module 160 at operation 906. The Capacity Compute Module 156 stores all data in Capacity Database 164, at operation 908. The Capacity Compute Module 156 returns to Capability Base Module 142, at operation 910.

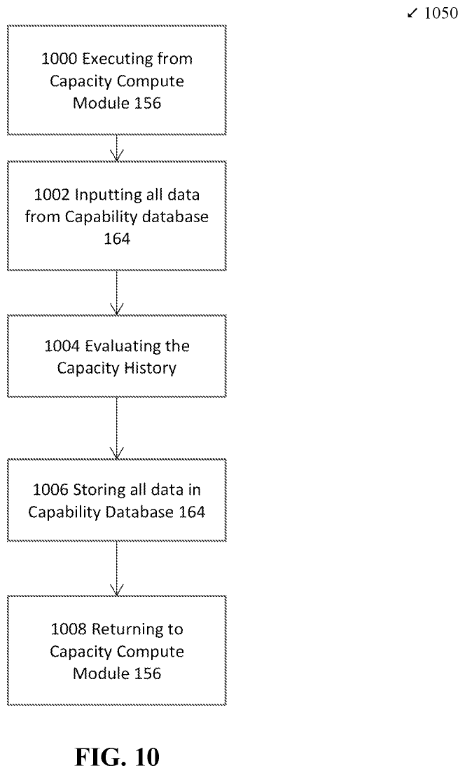

FIG. 10 is a flow diagram illustrating a process 1050 performed using a capacity history module. In FIG. 10, the Capacity History Module 158 executes from Capacity Compute Module 156, at operation 1000. The Capacity History Module 158 inputs all data from Capability database 164, at operation 1002. The Capacity History Module 158 uses all the Capability Database 164 to determine the capacity (amps Hrs) of the electric vehicle 102. In some embodiments, the Capacity History could be determined from history. The supercapacitor unit 108 appears to be a “linear use case” of capacity where the future capacity could be easily projected; that is, the time left for a given amperage can be predicted. In some embodiments, the Capacity determined from history may appear to be very nonlinear, and it would not be easy to project the supercapacitor unit 108 capacity.

It should be noted that capacity can be affected by many parameters, such as load in the vehicle, wind resistance, mechanical wear, etc., at operation 1004. The Capacity History Module 158 stores all data in Capability Database 164, at operation 1006. The Capacity History Module 158 returns to Capacity Compute Module 156, at operation 1008.

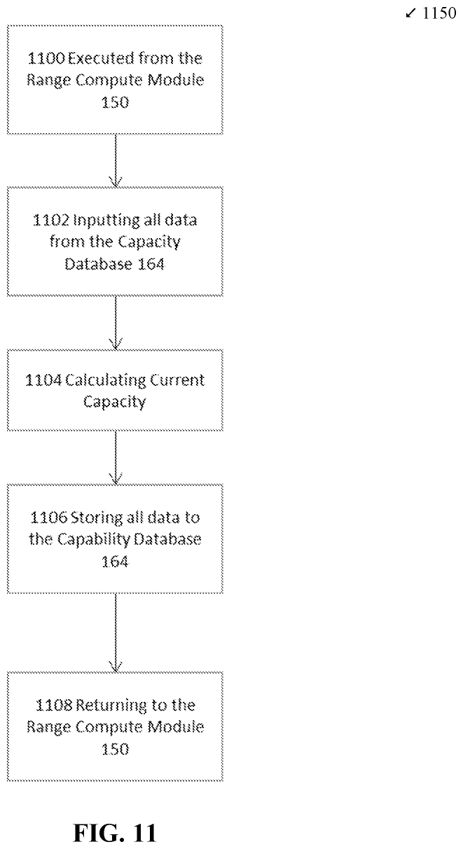

FIG. 11 is a flow diagram illustrating a process 1150 performed using a capacity current module. In FIG. 11, the Capacity Current Module 160 executes from the Range Compute Module 150 at operation 1100. The Capacity Current Module 160 inputs all data from the Capacity Database 164 at operation 1102. The Capacity Current Module 160 uses all the Capability Database 164 to determine the capacity of the electric vehicle 102. In some embodiments, the Current Capacity could be a capacity determined from history that appears to be linear. The use of the supercapacitor is easily projected in the time left on the current amperage. For example, the calculation could evaluate the capacity used on the current trip. This capacity could be used to find the time left at the current amperage taking into account the overall supercapacitor capacity subtracted from the capacity used already. If the capacity used is linear, metadata is also created, such as “Linear capacity used and Capacity prediction is highly accurate” In some embodiments, the capacity determined from history appears to be non-linear. If this is found, capacity cannot be easily predicted, and metadata such as “Capacity use variable—capacity cannot be predicted” is determined.

It should be noted that other types of calculation could be performed, such as (1) using a snapshot of historical data to determine if the capacity can be calculated or (2) using a moving average of historical data or others. It should also be noted that most electric vehicle 102 require a specific voltage range to operate, wherein the number of supercapacitors in series sets the voltage range. Complex supercapacitor systems (not shown) could swap in and out supercapacitor units to maintain voltage as supercapacitor units voltages change. Capacity is determined by the number of supercapacitor units in parallel. Complex supercapacitor systems (not shown) could swap in and out supercapacitor units to maintain capacitors as supercapacitor units' capacity changes at operation 1104. The Capacity Current Module 160 stores all data to the Capability Database 164, at operation 1106. The Capacity Current Module 160 returns to the Range Compute Module 150 at operation 1108.

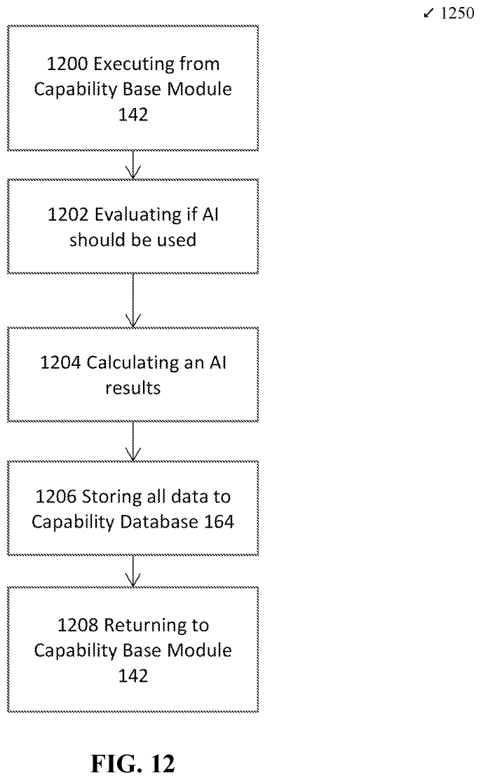

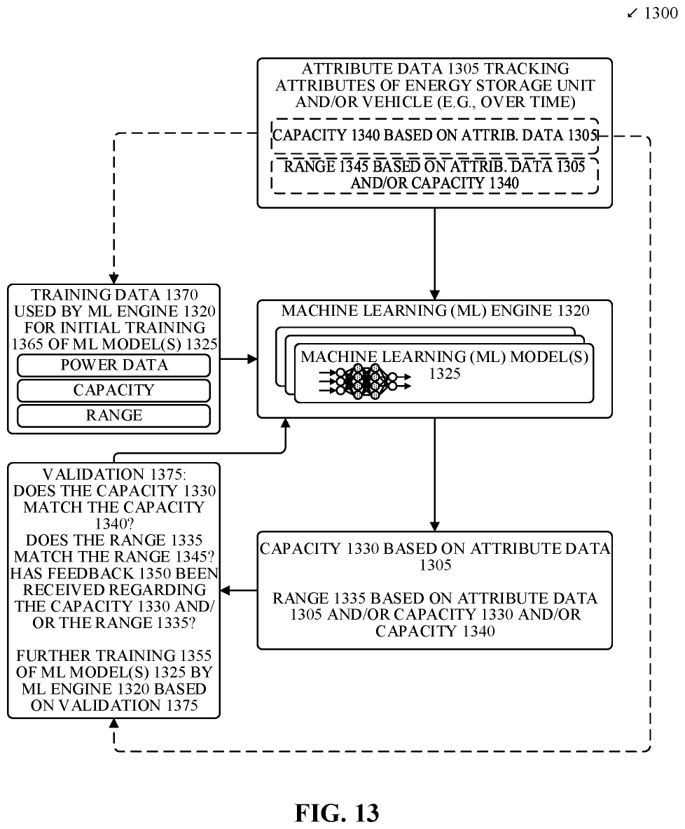

FIG. 12 is a flow diagram illustrating a process 1250 performed using an AI module. The AI module 162 may include the ML engine 1320 and/or the ML model(s) 1325 of FIG. 13. In FIG. 12, the AI Module 162 executes from Capability Base Module 142, at operation 1200. AI Module 162 may be used if Range or Capacity are both not easily predicted. AI Module 162 may be used to double-check a prediction. AI Module 162 may also be used if Range is predictable and Capacity is not, or vice versa. It should be noted that range can be affected by capacity and vice versa. For example, if the terrain is linear and distance is calculated for a given amount of charge used, predicting range based upon the current charge left may be in error, as the wind could change a lot and the capacity used may be very non-linear, even if the terrain is linear. Capacity may be a better determination of prediction versus range.

Knowing both the capacity and range history and their current prediction could be used to determine if AI should be used. For example, if the terrain is flat and range is easily predicted, but capacity is very variable, the range prediction may not be accurate; in general, the more capacity a battery has, the longer the range will be. However, factors such as terrain, stop-and-go traffic, outside temperature, age of electric vehicles all play a role. Knowing range from the history to determine future range is a reasonable means of predicting. Adding Capacity information to the range prediction will certainly enhance range prediction, especially if capacity is linear and terrain (and other parameters are constant). However, if the terrain is variable (or other factors are variable), capacity is the second parameter to help determine prediction (or vice versa). AI is used to find complex patterns in data based upon range or capacity, or both may be a helpful indicator from history if a current know pattern is found, at operation 1202. If AI Module 162 should be used because, for example, one or both of the range or the capacity are not easily predicted, AI Module 162 would use the data in the capability database 164, use all the history data of the vehicle and use the current range and capacity data to determine if a historical pattern is found. For instance, if a given route is taken a day to day on a golf course (same 18 holes, the same number of passengers, same up and down terrain, same wind resistance, then if the range data prediction (by time) and the capacity data prediction by time, even though they could both be non-linear, the AI Module 162 would find that pattern. If it were highly correlated, it would mean it was better to rely on the AI Module 162 prediction than either range or capacity or both. Metadata would be created “AI prediction highly accurate to final range or capacity” On the other hand, the AI Module could also match patterns of data for range alone or capacity alone to further enhance the prediction for each prediction by themselves. For instance, if the range can be highly predicted, the AI Module also finds from comprehensive history the same pattern, now the combined metadata that Range prediction is, for example, 2.1 miles, “highly predicted by current range information and highly predicted from AI.”, at operation 1204. The AI Module 162 stores all data to Capability Database 166.

FIG. 13 is a block diagram 1300 illustrating use of one or more trained machine learning models 1325 of a machine learning engine 1320 to identify an energy storage unit's capacity 1330 and/or a vehicle's range 1335 based on attribute data. The ML engine 1320 and/or the ML model(s) 1325 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 13, a graphic representing the trained ML model(s) 1325 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 1320 and/or the ML model(s) 1325 can be part of the AI/ML module 182.

Once trained via initial training 1365, the one or more ML models 1325 receive, as an input, attribute data 1305 that identifies attribute(s) of an energy storage unit (ESU) (e.g., type, voltage, discharge curve, capacitance, impedance, current, amperage, capacity, energy density, specific energy density, power density, temperature, temperature dependence, service life, physical attributes, charge cycle, discharge cycle, cycle life, deep discharge ability, discharge rate, charge rate, and the like) and/or attribute(s) of a vehicle (e.g., mileage, efficiency, ergonomics, aerodynamics, shape, geometry, weight, horsepower, brake power, turning radius, type, size, energy consumption rate, and the like). At least some of the attribute data 1305 may be received from one or more sensors, such as sensors to measure voltage, current, resistance, capacitance, inductance, frequency, power, temperature, and/or continuity. In some examples, the one or more sensors can include one or more voltmeters, ammeters, ohmmeters, capacimeters, inductance meters, wattmeters, multimeters, thermometers, thermistors, or a combination thereof. In some examples, the attribute data 1305 may be received from a design database 120 and/or a capability database 164, where the attribute data 1305 may be stored after measurement by the sensors. In some examples, for instance during validation 1375, the ML engine 1320 and/or the one or more ML models 1325 can also receive, as an additional input, a predetermined capacity 1340 of the ESU that is based on (or otherwise corresponds to) the attribute data 1305. In some examples, for instance during validation 1375, the ML engine 1320 and/or the one or more ML models 1325 can also receive, as an additional input, a predetermined range 1345 of the vehicle that is based on (or otherwise corresponds to) the attribute data 1305 and/or the predetermined capacity 1340.

In response to receiving at least the attribute data 1305 as an input(s), the one or more ML model(s) 1325 estimate the capacity 1330 of the ESU based on the attribute data 1305. The capacity 1330 of the ESU can identify the total capacity of the ESU, the remaining charge and/or remaining capacity of the ESU, or a combination thereof. The capacity may be an indication of the total and/or remaining voltage, current, resistance, capacitance, inductance, frequency, power, and/or charge of the ESU.

In response to receiving at least the attribute data 1305, the estimated capacity 1330, and/or the predetermined capacity 1340 as an input(s), the ML model(s) 1325 estimate the range 1335 of that the vehicle can travel given the capacity (e.g., the estimated capacity 1330 or the predetermined capacity 1340) of the ESU and/or given the attribute data 1305. The range 1335 of the vehicle may be identified as a distance that the vehicle can travel using the remaining capacity of the ESU, and can be expressed and/or estimated as a Euclidean distance, a Manhattan distance, a Minkowski distance, a Hamming distance, a cosine distance, another type of distance, or a combination thereof. In some examples, the vehicle may have more than one ESU, in which case the range 1335 of the vehicle may be identified as a distance that the vehicle can travel using the remaining respective capacities of the ESUs of the vehicle.

Estimating the capacity 1330 and/or the range 1335 can correspond to at least operations 206, 210, 304, 404, 602, 606, 700, 800, 804, 906, 1000, 1004, 1100, 1104, and/or 1204. It should be understood that the pre-determined capacity 1340 and/or the pre-determined range 1345 can likewise include any of the types of capacity and/or range data listed above with respect to the capacity 1330 and/or the range 1335.

Once the one or more ML models 1325 generate the capacity 1330 and/or the range 1335, the capacity 1330 and/or the range 1335 can be output to an output interface that can indicate the capacity 1330 and/or the range 1335 to a user (e.g., by displaying the capacity 1330 and/or the range 1335 or playing audio indicative of the capacity 1330 and/or the range 1335) and/or to the vehicle, which can adjust its settings and/or configurations based on the capacity 1330 and/or the range 1335, for instance to improve efficiency of the vehicle to extend the range beyond the estimated range 1335.

Before using the one or more ML models 1325 to generate the capacity 1330 and/or the range 1335 the ML engine 1320 performs initial training 1365 of the one or more ML models 1325 using training data 1370. The training data 1370 can include examples of attribute data (e.g., as in the attribute data 1305) and/or examples of pre-determined capacity and/or the predetermined range (e.g., as in the pre-determined capacity 1340 and/or the pre-determined range 1345). In some examples, the pre-determined capacity and/or the predetermined range in the training data 1370 are optimizations that the one or more ML models 1325 previously generated based on the attribute data in the training data 1370. In the initial training 1365, the ML engine 1320 can form connections and/or weights based on the training data 1370, for instance between nodes of a neural network or another form of neural network. For instance, in the initial training 1365, the ML engine 1320 can be trained to output the pre-determined capacity and/or the predetermined range in the training data 1370 in response to receipt of the corresponding attribute data in the training data 1370.

During a validation 1375 of the initial training 1365 (and/or further training 1355), the attribute data 1305 (and/or the exemplary power data in the training data 1370) is input into the one or more ML models 1325 to generate a capacity 1330 as described above. The ML engine 1320 performs validation 1375 at least in part by determining whether the estimated capacity 1330 matches the pre-determined capacity 1340 (and/or the pre-determined capacity in the training data 1370) and/or whether the estimated range 1335 matches the pre-determined range 1345 (and/or the pre-determined range in the training data 1370). If the capacity 1330 matches the pre-determined capacity 1340 during validation 1375, then the ML engine 1320 performs further training 1355 of the one or more ML models 1325 by updating the one or more ML models 1325 to reinforce weights and/or connections within the one or more ML models 1325 that contributed to the generation of the capacity 1330, encouraging the one or more ML models 1325 to generate similar capacity estimates given similar inputs. Similarly, if the range 1335 matches the pre-determined range 1345 during validation 1375, then the ML engine 1320 performs further training 1355 of the one or more ML models 1325 by updating the one or more ML models 1325 to reinforce weights and/or connections within the one or more ML models 1325 that contributed to the generation of the range 1335, encouraging the one or more ML models 1325 to generate similar range estimates given similar inputs. If the capacity 1330 does not match the pre-determined capacity 1340 during validation 1375, then the ML engine 1320 performs further training 1355 of the one or more ML models 1325 by updating the one or more ML models 1325 to weaken, remove, and/or replace weights and/or connections within the one or more ML models that contributed to the generation of the capacity 1330, discouraging the one or more ML models 1325 from generating similar capacity estimates given similar inputs. Similarly, if the range 1335 does not match the pre-determined range 1345 during validation 1375, then the ML engine 1320 performs further training 1355 of the one or more ML models 1325 by updating the one or more ML models 1325 to weaken, remove, and/or replace weights and/or connections within the one or more ML models that contributed to the generation of the range 1335, discouraging the one or more ML models 1325 from generating similar range estimates given similar inputs.

Validation 1375 and further training 1355 of the one or more ML models 1325 can continue once the one or more ML models 1325 are in use based on feedback 1350 received regarding the capacity 1330 and/or the range 1335. In some examples, the feedback 1350 can be received from a user via a user interface, for instance via an input from the user interface that approves or declines use of the capacity 1330 and/or the range 1335. In some examples, the feedback 1350 can be received from another component or subsystem of the vehicle (e.g., an energy control system), for instance based on whether the component or subsystem successfully uses the capacity 1330 and/or the range 1335, whether use the capacity 1330 and/or the range 1335 causes any problems for the component or subsystem (e.g., which may be detected using the sensors), whether use the capacity 1330 and/or the range 1335 are accurate, or a combination thereof. If the feedback 1350 is positive (e.g., expresses, indicates, and/or suggests approval of the capacity 1330 and/or the range 1335, success of the capacity 1330 and/or the range 1335, and/or accuracy the capacity 1330 and/or the range 1335), then the ML engine 1320 performs further training 1355 of the one or more ML models 1325 by updating the one or more ML models 1325 to reinforce weights and/or connections within the one or more ML models 1325 that contributed to the generation of the capacity 1330 and/or the range 1335, encouraging the one or more ML models 1325 to generate similar capacity and/or range estimates given similar inputs. If the feedback 1350 is negative (e.g., expresses, indicates, and/or suggests disapproval of the capacity 1330 and/or the range 1335, failure of the capacity 1330 and/or the range 1335, and/or inaccuracy of the capacity 1330 and/or the range 1335) then the ML engine 430 performs further training 1355 of the one or more ML models 1325 by updating the one or more ML models 1325 to weaken, remove, and/or replace weights and/or connections within the one or more ML models that contributed to the generation of the capacity 1330 and/or the range 1335, discouraging the one or more ML models 1325 to generate similar capacity and/or range estimates given similar inputs.

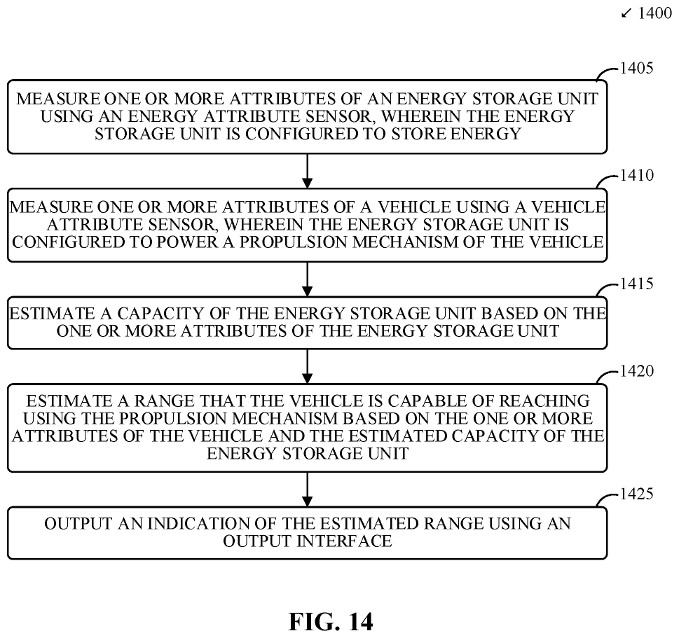

FIG. 14 is a flow diagram illustrating a process 1400 for energy-based vehicle analysis performed using a control system. The control system that performs the process 1400 can include the energy management system 100, the electric vehicle 102, energy management network and database 104, the cloud 106, the supercapacitor units 108 (and/or other ESUs such as batteries), the design database 120, the base module 122, the capability database 164, any system(s) that perform any of the processes of any of FIGS. 2-13, the ML engine 1320 of FIG. 13, an apparatus, a non-transitory computer-readable storage medium coupled to a processor, component(s) or subsystem(s) of any of these systems, or a combination thereof.

At operation 1405, the control system is configured to, and can, measure one or more attributes of an energy storage unit using an energy attribute sensor, wherein the energy storage unit is configured to store energy.

In some examples, the control system includes a charge management database that is configured to store data tracking the one or more attributes of the energy storage unit over time, wherein the control system is configured to estimate the capacity of the energy storage unit based on the data tracking the one or more attributes of the energy storage unit over time.

At operation 1410, the control system is configured to, and can, measure one or more attributes of a vehicle using a vehicle attribute sensor, wherein the energy storage unit is configured to power a propulsion mechanism of the vehicle.

In some examples, the control system includes a vehicle management database that is configured to store data tracking the one or more attributes of the vehicle over time, wherein the control system is configured to estimate the range of the vehicle based on the data tracking the one or more attributes of the vehicle over time.

At operation 1415, the control system is configured to, and can, estimate a capacity of the energy storage unit based on the one or more attributes of the energy storage unit.

In some examples, the control system is configured to, and can, input the one or more attributes of the energy storage unit into a trained machine learning model to estimate the capacity of the energy storage unit. In some examples, the control system is configured to, and can, input historical data tracking the one or more attributes of the energy storage unit over time into the trained machine learning model to estimate the capacity of the energy storage unit. In some examples, the control system is configured to, and can, use the estimated capacity of the energy storage unit as training data to update the trained machine learning model (e.g., as in the additional training 1355).

At operation 1420, the control system is configured to, and can, estimate a range that the vehicle is capable of reaching using the propulsion mechanism based on the one or more attributes of the vehicle and the estimated capacity of the energy storage unit.

In some examples, the control system is configured to, and can, input the one or more attributes of the vehicle and the estimated capacity of the energy storage unit into a trained machine learning model to estimate the range that the vehicle is capable of reaching using the propulsion mechanism. In some examples, the control system is configured to, and can, input historical data tracking the one or more attributes of the vehicle over time and historical data tracking the estimated capacity of the energy storage unit over time into the trained machine learning model to estimate the range that the vehicle is capable of reaching using the propulsion mechanism. In some examples, the control system is configured to, and can, use the estimated range of the energy storage unit as training data to update the trained machine learning model (e.g., as in the additional training 1355).

In some examples, the control system is configured to, and can, estimate the range that the vehicle is capable of reaching using the propulsion mechanism based also on a type of environment for the vehicle to reach the range in. The type of environment includes at least one of a plurality of predetermined types of environments, such as flat, rough, uphill, downhill, city, highway, narrow road, wide road, windy road, straight road, paved road, unpaved road, and the like.

At operation 1425, the control system is configured to, and can, output an indication of the estimated range using an output interface. In some examples, the control system is configured to, and can also output an indication of the estimated capacity using the output interface.

In some examples, the output interface includes a display, and wherein the control system is configured to cause the display to display the indication of the estimated range to output the indication of the estimated range.

In some examples, the output interface includes a communication interface, and wherein the control system is configured to cause the communication interface to transmit the indication of the estimated range to a recipient device to output the indication of the estimated range.

In some examples, the output interface is coupled to a propulsion controller for the vehicle, and wherein the control system is configured to change at least one setting that controls propulsion of the vehicle based on the indication of the estimated range. In some examples, the control system is configured to change the at least one setting that controls propulsion of the vehicle to improve energy efficiency of propulsion of the vehicle, for instance to increase the effective range of the vehicle beyond the range estimated in operation 1420.

At operation 1430, the control system is configured to, and can, output, using an output interface, a status of the plurality of power packs based on the flow of power. In some examples, the status is indicative of the capacity and/or the range. In some examples, the output interface includes a display, and the control system is configured to, and can, output the status of the plurality of power packs by displaying the status using the display. In some examples, the output interface includes a speaker, and the control system is configured to, and can, output the status of the plurality of power packs by playing the status using the speaker.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Aspects of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, aspects of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A system for energy-based vehicle analysis, the system comprising:
an energy storage unit that is configured to store energy;
an energy attribute sensor that is configured to measure one or more attributes of the energy storage unit;
a vehicle attribute sensor that is configured to measure one or more attributes of a vehicle, wherein the energy storage unit is configured to power a propulsion mechanism of the vehicle;
a control system comprising a processor with access to a memory, wherein the control system is configured to estimate a capacity of the energy storage unit based on the one or more attributes of the energy storage unit, wherein the control system is configured to estimate a range that the vehicle is capable of reaching using the propulsion mechanism based on the one or more attributes of the vehicle and the estimated capacity of the energy storage unit; and
an output interface coupled to the control system and configured to output an indication of the estimated range.

2. The system of claim 1, further comprising:
a charge management database that is configured to store data tracking the one or more attributes of the energy storage unit over time, wherein the control system is configured to estimate the capacity of the energy storage unit based on the data tracking the one or more attributes of the energy storage unit over time.

3. The system of claim 1, further comprising:
a vehicle management database that is configured to store data tracking the one or more attributes of the vehicle over time, wherein the control system is configured to estimate the range of the vehicle based on the data tracking the one or more attributes of the vehicle over time.

4. The system of claim 1, wherein the control system is configured to input the one or more attributes of the energy storage unit into a trained machine learning model to estimate the capacity of the energy storage unit.

5. The system of claim 4, wherein the control system is configured to also input historical data tracking the one or more attributes of the energy storage unit over time into the trained machine learning model to estimate the capacity of the energy storage unit.

6. The system of claim 4, wherein the control system is configured to use the estimated capacity of the energy storage unit as training data to update the trained machine learning model.

7. The system of claim 1, wherein the control system is configured to input the one or more attributes of the vehicle and the estimated capacity of the energy storage unit into a trained machine learning model to estimate the range that the vehicle is capable of reaching using the propulsion mechanism.

8. The system of claim 7, wherein the control system is configured to also input historical data tracking the one or more attributes of the vehicle over time and historical data tracking the estimated capacity of the energy storage unit over time into the trained machine learning model to estimate the range that the vehicle is capable of reaching using the propulsion mechanism.

9. The system of claim 7, wherein the control system is configured to use the estimated range of the energy storage unit as training data to update the trained machine learning model.

10. The system of claim 1, wherein the control system is configured to estimate the range that the vehicle is capable of reaching using the propulsion mechanism based also on a type of environment for the vehicle to reach the range in, wherein the type of environment includes at least one of a plurality of predetermined types of environments.

11. The system of claim 1, wherein the output interface is also configured to output an indication of the estimated capacity.

12. The system of claim 1, wherein the output interface includes a display, and wherein the control system is configured to cause the display to display the indication of the estimated range to output the indication of the estimated range.

13. The system of claim 1, wherein the output interface includes a communication interface, and wherein the control system is configured to cause the communication interface to transmit the indication of the estimated range to a recipient device to output the indication of the estimated range.

14. The system of claim 1, wherein the output interface is coupled to a propulsion controller for the vehicle, and wherein the control system is configured to change at least one setting that controls propulsion of the vehicle based on the indication of the estimated range.

15. The system of claim 14, wherein the control system is configured to change the at least one setting that controls propulsion of the vehicle to improve energy efficiency of propulsion of the vehicle.

16. A method for energy-based vehicle analysis, the method comprising:
measuring one or more attributes of an energy storage unit using an energy attribute sensor, wherein the energy storage unit is configured to store energy;
measuring one or more attributes of a vehicle using a vehicle attribute sensor, wherein the energy storage unit is configured to power a propulsion mechanism of the vehicle;
estimating a capacity of the energy storage unit based on the one or more attributes of the energy storage unit;
estimating a range that the vehicle is capable of reaching using the propulsion mechanism based on the one or more attributes of the vehicle and the estimated capacity of the energy storage unit; and
outputting an indication of the estimated range using an output interface.

17. The method of claim 16, further comprising:
inputting the one or more attributes of the energy storage unit into a trained machine learning model to estimate the capacity of the energy storage unit.

18. The method of claim 16, further comprising:
inputting the one or more attributes of the vehicle and the estimated capacity of the energy storage unit into a trained machine learning model to estimate the range that the vehicle is capable of reaching using the propulsion mechanism.

19. The method of claim 16, further comprising:
changing at least one setting that controls propulsion of the vehicle based on the indication of the estimated range.

20. A non-transitory computer readable storage medium having embodied thereon a program, wherein the program is executable by a processor to perform a method of energy-based vehicle analysis, the method comprising:
measuring one or more attributes of an energy storage unit using an energy attribute sensor, wherein the energy storage unit is configured to store energy;
measuring one or more attributes of a vehicle using a vehicle attribute sensor, wherein the energy storage unit is configured to power a propulsion mechanism of the vehicle;
estimating a capacity of the energy storage unit based on the one or more attributes of the energy storage unit;
estimating a range that the vehicle is capable of reaching using the propulsion mechanism based on the one or more attributes of the vehicle and the estimated capacity of the energy storage unit; and
outputting an indication of the estimated range using an output interface.
